(19) United States
(12) Patent Application Publication
(10) Pub. No.: US 2001/0033313 A1
(43) Pub. Date: Oct. 25, 2001

(54) Ink jet head and fabrication method of the same

(76) Inventors: Kenichi Ohno, Tokyo (JP); Kenichiro Suzuki, Tokyo (JP); Yuji Akimoto, Tokyo (JP); Torahiko Kanda, Tokyo (JP)

Correspondence Address: McGinn & Gibb, PLLC, Suite 200, 8321 Old Courthouse Road, Vienna, VA, 22182-3817, US

(21) Appl. No.: 09/813,010

(22) Filed: Mar. 21, 2001

(30) Foreign Application Priority Data
Mar. 21, 2000 (JP) 078953/2000
Oct. 6, 2000 (JP) 307049/2000
Mar. 21, 2000 (JP) 078871/2000

(51) Int. Cl. B41J 2/045

(52) U.S. Cl. 347/68

(57) ABSTRACT

Nozzles for jetting ink droplets and ink chambers connected to the respective nozzles are formed in a substrate. Ink filling the ink chambers is pressurized. Ink pools are also formed adjacent to the ink chambers through partition walls, for supplying ink to the ink chambers. The partition wall makes a predetermined angle with respect to a surface of the substrate. The ink pools are formed adjacent to the ink chambers through thin partition walls. Further, the nozzles are arranged in a line and row matrix and the line of nozzles or the side of ink pools makes a constant angle with respect to a printing direction.

### BACKGROUND OF THE INVENTION

1. Field of the Invention

The present invention relates to an ink jet head for recording an image, etc., by jetting ink droplets to a recording medium and a fabrication method of the ink jet head.

2. Description of the Related Art

Main portions constituting an ink jet head are nozzles for jetting ink droplets, ink chambers provided below the respective nozzles, for pressuring ink therein to jet ink droplets through the nozzles, and ink pools for supplying ink to the ink chambers. Further, ink passages are provided between the ink pools and the ink chambers. An ink pressuring mechanism is provided in each of the ink chambers and a cover plate of the ink chamber exists between the pressuring mechanism and the ink chamber.

Among the prior arts, JP H09-57981A and JP H04-312853A disclose structures in each of which nozzles and ink chambers are formed in one substrate. In each of the prior arts, the nozzles are provided in one face of a crystalline plate and the ink chambers forming tapered or bell-shaped spaces are provided below the nozzles. In each of JP H5-309835A and JP H6-31914A, ink chambers, ink pools and ink passages are formed in one substrate. Further, in JP H6-218932A, ink chambers and a cover plate are formed in one substrate.

In one of the prior arts, the nozzles and the ink chambers are formed in one substrate and, thereafter, ink pools and the ink passages, which are formed in another substrate, are bonded to the one substrate. In another of the prior arts, the ink chambers, the ink pools and the ink passages are formed in one substrate and, thereafter, the nozzles formed in another substrate are connected thereto. In a further example of the prior arts, the ink chambers and the cover plate are formed in one substrate and, thereafter, opening portions of the nozzles, which are formed in another substrate, are bonded thereto.

Therefore, in the prior arts, there may be a case where the peeling occurs in the bonded portions, so that there is a problem that it is impossible to maintain air-tightness of spaces. Further, the preciseness and producibility of the ink jet head is lowered by the required bonding or connecting steps.

### SUMMARY OF THE INVENTION

The present invention was made in view of the above mentioned circumstances and an object of the present invention is to provide an ink jet head having superior producibility, which is realized by improving the reliability and the yield of parts by forming nozzles, ink chambers, ink pools and ink passages, which are main portions of the ink jet head, in one substrate.

Another object of the present invention is to provide an ink jet head capable of avoiding electrostatic charging of nozzle portions.

Another object of the present invention is to provide an ink jet head in which the density of nozzles can be increased and whose outer size can be reduced.

A further object of the present invention is to provide an ink jet head with which the number of ink jet heads, which are obtainable from a single substrate, can be increased and the cost of the ink jet head can be reduced.

According to a first aspect of the present invention, an ink jet head comprises nozzles formed in a silicon substrate for jetting ink droplets, ink chambers formed in the silicon substrate and connected to the respective nozzles for pressurizing ink filling the ink chambers and ink pools for supplying ink to the ink chambers through partition walls, the partition wall being formed at a predetermined angle with respect to a surface of the silicon substrate. The ink pools are provided adjacent to the ink chambers through thin partition walls, respectively.

The nozzles of the ink jet head extend perpendicularly to crystal face {100} of the silicon substrate. The ink chambers connected to the nozzles for pressurizing ink filling the ink chambers are formed as wall faces including crystal face {111} and wall faces of the ink pools provided adjacent to the ink chambers for supplying ink to the ink chambers are in crystal face {111}.

In more detail, the ink jet head may have a structure including the nozzles formed in the silicon substrate and extending perpendicularly to a surface of the silicon substrate and the ink chambers formed in the silicon substrate and connected to the respective nozzles, for pressurizing ink filling the ink chambers. A cross section of the ink chamber is tapered toward the related nozzle. Further, the structure includes the ink pools each for supplying ink to a plurality of the ink chambers are connected to the ink chambers through the partition walls and a cross section of each ink pool is tapered in a direction which is reverse to the tapering of the ink chambers.

In this structure, the tapering of the cross section of the ink chamber and the tapering of the cross section of the ink pool are opposite each other, so that it is possible to reduce the area occupied by the ink chamber and the related ink pool when they are provided adjacently each other.

Alternatively, the ink jet head may have a structure including the nozzles formed in the silicon substrate and extending perpendicularly to the surface of the silicon substrate and the ink chambers formed in the silicon substrate and connected to the respective nozzles for pressurizing ink filling the ink chambers. Cross sections of the ink chamber and the ink pool are tapered with respect to the surface of the substrate in which the nozzles are formed.

In each of the above mentioned structures of the ink jet head of the present invention, a portion of the ink chamber may be tapered in a reverse direction.

Alternatively, the ink jet head may have a structure including the nozzles formed in the silicon substrate and extending perpendicularly to the surface of the silicon substrate and the ink chambers formed in the silicon substrate and connected to the respective nozzles, for pressurizing ink filling the ink chambers. The structure further includes the ink pools provided adjacent to the ink chambers, for supplying ink to the ink chambers and the wall faces of the ink chamber and the ink pool are formed substantially perpendicularly to the substrate. The diameter of the nozzle may be stepped such that the diameter thereof is reduced toward the nozzle opening.

In each of these structures of the ink jet head of the present invention, it is preferable to form an ink supply port between an ink chamber and an ink pool or it is preferable to bond a cover plate formed with ink supply grooves each connecting the ink pool to the ink chamber to the substrate. Further, it is preferable to provide a pressure generating mechanism for pressurizing ink in an ink chamber on a bottom of the ink chamber.

According to a second aspect of the present invention, a fabrication method of an ink jet head comprises the steps of forming a high density impurity diffusion layer on one surface of a silicon substrate, forming an etching resistive mask film on the one surface of the silicon substrate, forming opening portions in the etching resistive mask film at locations thereof corresponding to the ink chambers and the ink pools to be formed in the silicon substrate, forming the ink chambers and the ink pools by performing anisotropic etching of the substrate through the opening portions and closing open portions of the thus formed ink chambers and the ink pools.

The step of forming the opening portions for forming the ink chambers and ink pools includes, for example, the step of forming periodic grooves. The step of closing the open portions of the ink chambers and the ink pools includes, for example, the step of oxidizing residual silicon on the open portions.

The step of forming the ink chambers and the ink pools by anisotropic etching may include the step of forming ink supply ports between the ink chambers and the ink pools.

The step of forming the ink chambers and the ink pools by anisotropic etching includes the step of forming ink supply ports between the ink chambers and the ink pools and may include the step of bonding a cover plate to the silicon substrate formed with the ink supply ports connecting the ink pools to the ink chambers.

The step of closing the open portions of the ink chambers and the ink pools may include the step of bonding a cover plate formed with ink supply grooves connecting the ink pools to the ink chambers to the silicon substrate.

The fabrication method may further include the step of providing a piezo electric element for applying jet pressure to ink within each ink chamber on a bottom of the ink chamber.

According to this fabrication method, it is possible to form the ink chambers and the ink pools from one surface of the substrate.

Alternatively, the fabrication method may comprise the steps of forming high density impurity diffusion layers on both surfaces of a silicon substrate, forming etching resistive mask films on the surfaces of the silicon substrate, forming opening portions in the etching resistive mask film on one surface of the substrate, in which nozzles are opened, at locations thereof corresponding to the ink pools and opening portions in the etching resistive mask film on the other surface of the substrate at locations thereof corresponding to the ink chambers, forming the ink chambers and the ink pools by performing anisotropic etching of the substrate through the opening portions, closing the thus formed open portions of the ink pools and closing open portions of the thus formed ink chambers.

In this case, the step of forming the opening portions for forming the ink chambers and the ink pools includes, for example, the step of providing periodic grooves in the opening portions of the ink pools.

Each of the steps of closing the open portions of the ink chambers and the ink pools includes, for example, the step of oxidizing residual silicon on the open portions of the ink pools.

The step of forming the ink chambers and the ink pools by anisotropic etching may include the step of forming ink supply ports between the ink chambers and the ink pools.

Alternatively, the step of forming the ink chambers and the ink pools by anisotropic etching includes the step of forming ink supply ports between the ink chambers and the ink pools and may include the step of bonding a cover plate to the silicon substrate formed with the ink supply ports connecting the ink pools to the ink chambers.

The step of closing the open portions of the ink chambers and the ink pools may include the step of forming ink supply ports between the ink chambers and the ink pools and may include the step of bonding a cover plate to the silicon substrate formed with the ink supply ports connecting the ink pools to the ink chambers.

The step of forming the ink chambers and the ink pools by anisotropic etching may include the step of forming ink supply ports between the ink chambers and the ink pools and the step of closing the open portions of the ink chambers and the ink pools may include the step of oxidizing residual silicon on the open portions of the ink chambers.

The fabrication method preferably comprises the step of providing a piezo electric element for applying jet pressure to ink within each ink chamber on an opposite side of the ink chamber to the nozzle.

According to this fabrication method, it is possible to form the ink chambers and the ink pools from both surfaces of the silicon substrate. Therefore, it is possible to provide the structure in which the tapering of the ink chamber and the tapering of the ink pool are opposite each other.

Alternatively, the fabrication method comprises the steps of forming etching resistive protection films on both surfaces of a silicon substrate, forming opening portions in the etching resistive protection films on both surfaces of the silicon substrate at locations thereof corresponding to the ink chambers and the ink pools to be formed, for etching the ink chambers and the ink pools therethrough, forming the ink chambers and the ink pools to predetermined depths from one of the surfaces of the substrate, which is opposite to a surface in which the nozzles are to be opened, by dry-etching and closing the open portions of the ink pools and the ink chambers.

The fabrication method further includes the step of forming the nozzles by dry-etching and, in the step of forming the ink chambers, each ink chamber can be formed such that an upper portion of the ink chamber is stepped.

The step of forming the ink chambers and the ink pools includes the step of forming ink supply ports between the ink chambers and the ink pools and may include the step of bonding a cover plate to the silicon substrate formed with the ink supply ports connecting the ink pools to the ink chambers.

The step of closing the open portions of the ink chambers and the ink pools may include the step of bonding a cover plate formed with the ink supply ports connecting the ink pools to the ink chambers to the silicon substrate.

The fabrication method preferably comprises the step of providing a piezo electric element for applying jet pressure to ink within each ink chamber on an opposite side of the ink chamber to the nozzle.

According to this fabrication method, it is possible to provide a structure in which the ink pools are provided adjacent to the ink chambers and the wall faces of the ink chamber and the ink pool are formed substantially perpendicularly to the substrate.

Alternatively, the fabrication method comprises the steps of forming a high density impurity diffusion layer on one surface of a silicon substrate, forming an etching resistive mask films on the one surface of the silicon substrate, forming opening portions in the etching resistive mask film on the one surface of the silicon substrate at locations thereof corresponding to the ink chambers and the ink pools, forming the ink chambers and the ink pools by anisotropic etching of the substrate through the opening portions and closing the thus formed open portions of the ink chambers and the ink pools.

The step of forming the opening portions for forming the ink chambers and the ink pools includes, for example, the step of providing periodic grooves in the silicon substrate.

Each of the steps of closing the open portions of the ink chambers and the ink pools includes, for example, the step of oxidizing residual silicon on the open portions of the ink chambers and the ink pools.

The step of forming the ink chambers and the ink pools by anisotropic etching may include the step of forming ink supply ports between the ink chambers and the ink pools.

The step of forming the ink chambers and the ink pools by anisotropic etching includes the step of forming ink supply ports between the ink chambers and the ink pools and may include the step of bonding a cover plate to the silicon substrate formed with the ink supply ports connecting the ink pools to the ink chambers.

The step of closing the open portions of the ink chambers and the ink pools may include the step of bonding a cover plate formed with ink supply grooves between the ink chambers and the ink pools to the silicon substrate.

The fabrication method may include the step of providing a piezo electric element for applying jet pressure to ink within each ink chamber on an opposite side of the ink chamber to the nozzle.

According to this fabrication method, it is possible to provide a structure of the ink chamber in which a portion of the ink chamber is tapered in an opposite direction.

By providing the nozzles and the ink pools in one substrate in this manner, it is possible to realize an ink jet head having high producibility due to improved reliability of head and the yield of parts. Further, since an electrically conductive layer is formed on the nozzle by the high density impurity diffusion layer, it is possible to prevent electrostatic charging due to friction caused by wiping from occurring.

According to another aspect of the present invention, an ink jet head is provided, in which nozzles are arranged in a matrix of lines tilted with respect to a main scan direction (printing direction) by a constant angle and rows orthogonal to the main scan direction and the line direction of the nozzle arrangement or a lengthwise direction of the ink pools is coincident with the crystal orientation of the substrate.

That is, the ink jet head is featured by comprising a plurality of nozzles arranged in a matrix of a plurality of lines tilted with respect to a main scan direction by a constant angle and a plurality of rows orthogonal to the main scan lines, a plurality of ink chambers provided correspondingly to the respective nozzles and pressurizing ink filling them, a plurality of ink pools provided along the respective lines for supplying ink to the respective ink chambers, ink passages communicating the ink pools with the ink chambers and a pressure generating mechanism provided in each ink chamber for generating pressure therein, wherein at least the ink chambers and the ink pools are formed in a crystalline plate and sides of the ink pools forming a longitudinal direction is coincident with crystal orientation of the crystalline plate.

The crystalline plate is a silicon substrate having a surface in crystal face {100} and the sides of the ink pools forming the longitudinal direction of the ink pools are preferably formed in crystal face {111}.

The ink chamber takes in the form of a pyramid having crystal face {111} as wall faces with respect to the nozzle and, preferably, wall faces of the other sides of the ink pool are in parallel to the wall faces of the ink chamber and a cross section of the ink pool is reverse-tapered.

Assuming that a required resolution is N(dpi (dot per inch) or ppi (pixel per inch)) and a pitch between nozzles, which are adjacent in the lengthwise direction of the ink pool, is L (mm), one of axes of the ink pool is tilted by θ=arcsin 25.4/N/L with respect to the main scan direction.

It is preferable that the direction of the nozzle rows in extreme ends of the respective nozzle lines is arranged on an axis tilted with respect to the crystal orientation of the crystalline plate by θ=arcsin 25.4/N/L.

The ink pools formed along the nozzle lines are connected to a common ink pool and a lengthwise axis of the common ink pool is preferably tilted with respect to the main scan direction by θ=arcsin 25.4/N/L.

An outer configuration of the ink jet head is constructed with four sides tilted with respect to the crystal orientation of the crystalline plate by θ=arcsin 25.4/N/L.

Further, the ink jet head is preferably moved in parallel to or perpendicularly to the sides constituting the outer configuration thereof when a printing is performed.

In such structure, the ink chambers and the ink pools are efficiently arranged in the ink jet head, so that it is possible to arrange the nozzles at high density to thereby make the ink jet head compact. Further, since it is possible to efficiently arrange a plurality of ink jet heads in one silicon substrate with minimum loss thereof and to cut it to separate the ink jet heads each other, it is possible to increase the number of ink jet heads obtainable from the silicon substrate to thereby reduce the cost of the ink jet head. Since the rows of the nozzles are arranged perpendicularly to the printing direction on a printing sheet, the amount of movement of the ink jet head during printing is small, so that it is possible to make a printing drive control simple.

According another aspect of the present invention, an ink jet head comprises a substrate, nozzle opening portions provided in a surface of the substrate for jetting ink, ink chambers provided in the substrate and connected to the respective nozzle opening portions for pressurizing ink filling them and a pressure generating mechanism for applying pressure to ink in each ink chamber, the pressure generating mechanism being provided through a thinned substrate portions on an opposite surface of the substrate to the surface in which the nozzle opening portions are formed.

That is, this ink jet head according to the present invention is featured by that the nozzle opening portions for jetting ink and the ink chambers connected to the opening portions for applying pressure to ink filling them are formed in the substrate and the thinned substrate portion is provided on the surface of the substrate opposite to the surface in which the opening portions are formed.

In detail, the nozzle opening portions extending vertically of the substrate are formed in one surface of the substrate and the ink chamber connected to each nozzle opening portion for applying pressure to ink filling the ink chamber is provided in the substrate. A cross section of the ink chamber is tapered with respect to the nozzle opening portion and a bottom of the ink chamber is covered by a thinned portion of the substrate.

In more detail, the nozzle opening portions are formed perpendicularly to crystal face {100} of the silicon substrate and the ink chamber connected to each nozzle opening portion for applying pressure to ink filling the same ink chamber is provided as a wall face in crystal face {111}. The ink chambers are covered by a residual portion of the silicon substrate on the other surface of the silicon substrate.

In a concrete structure, the nozzle opening portions extending vertically of the silicon substrate are formed in one surface of the silicon substrate and the ink chamber connected to each nozzle opening portion for applying pressure to ink filling the same ink chamber is provided in the silicon substrate. The cross section of the ink chamber is tapered toward the nozzle opening portion by etching and the bottom of the ink chamber is covered by thinned etching residue of the silicon substrate.

The thin etching residue of the silicon substrate is formed by oxidizing silicon in the form of slits or formed by a high density impurity diffusion layer, which is resistive to etching.

Alternatively, a thin polysilicon film is formed on one surface of the silicon substrate, the nozzle opening portions are formed vertically of the silicon substrate from the other surface of the silicon substrate, the ink chambers, which are connected to the respective nozzle opening portions for applying pressure to ink filling the ink chambers, are provided. The cross section of the ink chamber is tapered toward the nozzle opening portion and the bottom surface of the ink chamber is covered by etching residue of the thin polysilicon film.

Alternatively, a silicon film or a thin polysilicon film is formed on one surface of the silicon substrate through a silicon oxide film, the nozzle opening portions are formed vertically of the silicon substrate from the other surface of the silicon substrate, the ink chambers, which are connected to the respective nozzle opening portions, are provided. The cross section of the ink chamber is tapered toward the nozzle opening portion by etching and the bottom surface of the ink chamber is covered by etching residue of the silicon film or the thin polysilicon film.

In such structure, it is preferable to provide the ink pool for supplying ink to the ink chambers through ink supply ports adjacent to the ink chambers.

According to another aspect of the present invention, a fabrication method of an ink jet head comprises the steps of forming a high density impurity diffusion layer on one surface of the silicon substrate, forming an etching resistive mask film on the one surface of the silicon substrate, providing etching openings in locations of the etching resistive mask film on the one surface of the silicon substrate, at which the ink chambers are to be formed, forming the ink chambers from the one surface by anisotropic etching and closing the opening portions of the thus formed ink chambers.

The step of forming the opening portions for forming the ink chambers may include the step of forming periodic grooves. The step of closing the open portions of the ink chambers may include the step of oxidizing etching residue of silicon on the open portions.

Alternatively, the fabrication method comprises the steps of forming a high density impurity diffusion layer on one surface of the silicon substrate, forming an etching resistive mask film on the surface of the silicon substrate, forming nozzle opening portions from the other surface of the silicon substrate and forming openings to a depth enough to form the ink chambers, by dryetching, and forming the ink chambers through the nozzle opening portions by anisotropic etching such that the high density impurity diffusion layer is left on the other surface of the silicon substrate.

Alternatively, the fabrication method comprises the steps of forming a polysilicon film on one surface of the silicon substrate, forming a high density impurity diffusion layer on the polysilicon film, forming nozzle opening portions from the other surface of the silicon substrate and forming openings to a depth enough to form the ink chambers, by dry-etching, and forming the ink chambers through the nozzle opening portions by anisotropic etching such that the high density impurity diffusion layer is left on the other surface of the silicon substrate.

Alternatively, the fabrication method of the ink jet head comprises the steps of forming a silicon film or a polysilicon film on one surface of the silicon substrate through a silicon oxide film, forming a high density impurity diffusion layer on the silicon film or the polysilicon film and the other surface of the silicon substrate, forming nozzle opening portions from the other surface of the silicon substrate and forming openings to a depth enough to form the ink chambers, by dry-etching, and forming the ink chambers through the nozzle opening portions by anisotropic etching such that the high density impurity diffusion layer on the silicon film or the polysilicon film is left on the one surface of the silicon substrate

In this case, the crystal orientation of the surfaces of the silicon substrate is [100] and the anisotropic etching is preferably performed such that crystal orientation of the wall faces of the ink chamber becomes [111]. Further, the high density impurity diffusion layer is preferably a high density boron diffusion layer.

With such structure, the bonding of the cover plate to the substrate becomes unnecessary, so that the ink jet head capable of improving the reliability and capable of improving the yield of parts can be realized. Further, when an electrically conductive layer is formed in the nozzle opening portion by the high density impurity diffusion layer, electrostatic charging can be avoided against friction by such as wiping.

### BRIEF DESCRIPTION OF THE DRAWINGS

Preferred embodiments of the present invention will be described with reference to the accompanying drawings, in which:

FIG. 1 is a plan view showing a whole ink jet head schematically;

FIG. 2 is a cross section of an ink jet head according to a first embodiment of the present invention;

FIG. 3 shows, in an enlarged scale, a portion of the ink jet head according to the first embodiment as well as the fourth embodiment of the present invention;

FIG. 4 shows, in an enlarged scale, a portion of the ink jet head according to the second, the third and the fifth embodiments of the present invention;

FIGS. 5a to 5i are cross sections showing fabrication steps of a first fabrication method for fabricating the ink jet head according to the first embodiment of the present invention;

FIG. 6 shows a pattern of straight lined ink pools;

FIG. 7 shows a pattern of V-shaped ink pools;

FIGS. 8a to 8h illustrate a fabrication method for fabricating a vibration plate;

FIGS. 9a to 9i are cross sections showing fabrication steps of a second fabrication method for fabricating the ink jet head according to the first embodiment of the present invention;

FIG. 10 shows a pattern of a lower surface of a substrate in the second fabrication method;

FIG. 11 shows a state of the lower surface of the substrate in the second fabrication method;

FIGS. 12a to 12h are cross sections showing fabrication steps of a third fabrication method for fabricating the ink jet head according to the first embodiment of the present invention;

FIG. 13 shows a pattern for forming ink chambers and ink supply ports in the third fabrication method;

FIG. 14 is a cross section of an ink jet head according to a second embodiment of the present invention;

FIGS. 15a to 15h are cross sections of the ink jet head according to the second embodiment, showing a first and second fabrication methods;

FIGS. 16a to 16h are cross sections of the ink jet head according to the second embodiment, showing a third fabrication method;

FIG. 17 shows patterns of ink chambers, ink supply ports and ink pools in the third fabrication method for fabricating the ink jet head according to the second embodiment of the present invention;

FIG. 18 is a cross section of an ink jet head according to a third embodiment of the present invention;

FIGS. 19a to 19i are cross sections showing fabrication steps of a first and second fabrication methods for fabricating the ink jet head according to the third embodiment of the present invention;

FIG. 20 is a dimensional figure of a portion of the ink jet head according to the third embodiment of the present invention, which is in the vicinity of a nozzle thereof;

FIG. 21 is a cross section of an ink jet head according to a fourth embodiment of the present invention;

FIGS. 22a to 22i are cross sections showing fabrication steps of a first and second fabrication methods for fabricating the ink jet head according to the fourth embodiment of the present invention;

FIGS. 23a to 23c are cross sections of the ink jet head according to the fourth embodiment of the present invention, illustrating the formation of the ink chambers;

FIGS. 24a to 24i are cross sections showing fabrication steps of a third fabrication method for fabricating the ink jet head according to the fourth embodiment of the present invention;

FIG. 25 is a cross section of an ink jet head according to a fifth embodiment of the present invention;

FIGS. 26a to 26h are cross sections showing fabrication steps of a first and second fabrication methods for fabricating the ink jet head according to the fifth embodiment of the present invention;

FIGS. 27a to 27h are cross sections showing fabrication steps of a third fabrication method for fabricating the ink jet head according to the fifth embodiment of the present invention;

FIG. 28 shows a whole ink jet head according to a sixth embodiment of the present invention;

FIG. 29 is a figure, showing an angle of a line of ink pools or ink chambers with respect to a main scan direction;

FIG. 30 is a cross section of an ink jet head according to a seventh embodiment of the present invention;

FIGS. 31a to 31h are cross sections of the ink jet head of the first embodiment of the present invention, showing fabrication steps thereof;

FIG. 32 is a cross section of an ink jet head according to an eighth embodiment of the present invention;

FIG. 33 is a cross section of a polysilicon vibration plate head, which is a modification of the eighth embodiment of the present invention;

FIGS. 34a to 34j are cross sections of the polysilicon vibration plate head, showing the fabrication steps of the modification;

FIG. 35 is a cross section of an SOI head, which is another modification of the eighth embodiment of the present invention; and

FIGS. 36a to 36j are cross sections of the SOI head, showing the fabrication steps thereof.

### DETAILED DESCRIPTION OF THE PREFERRED EMBODIMENTS

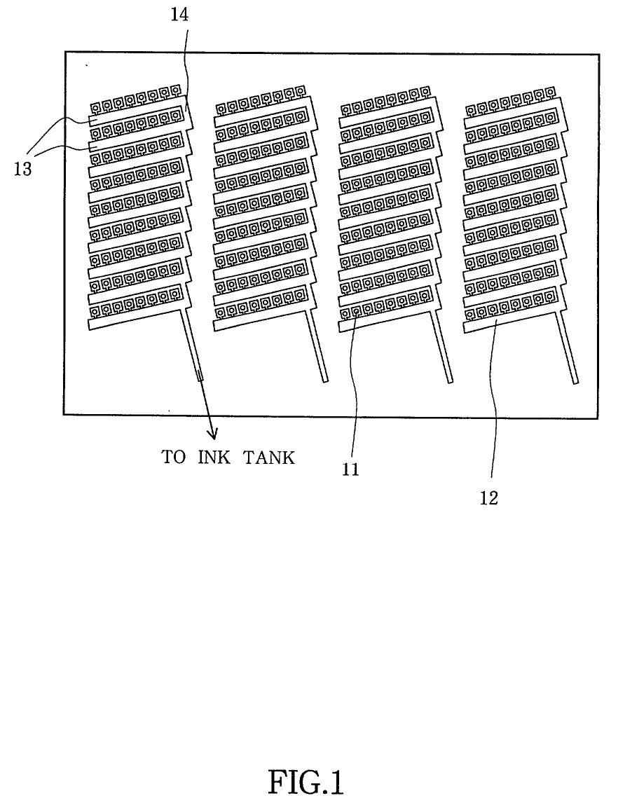

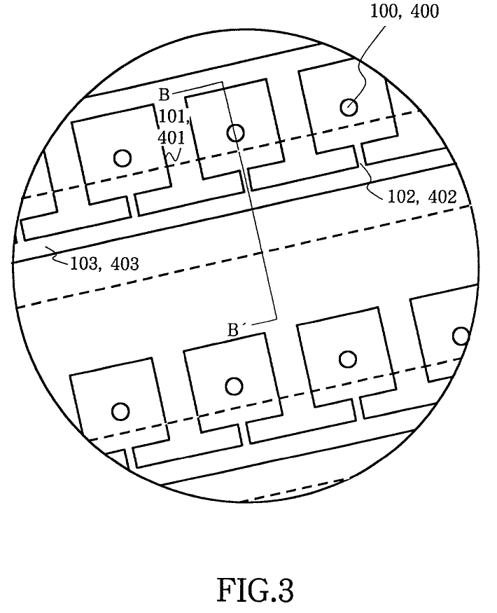

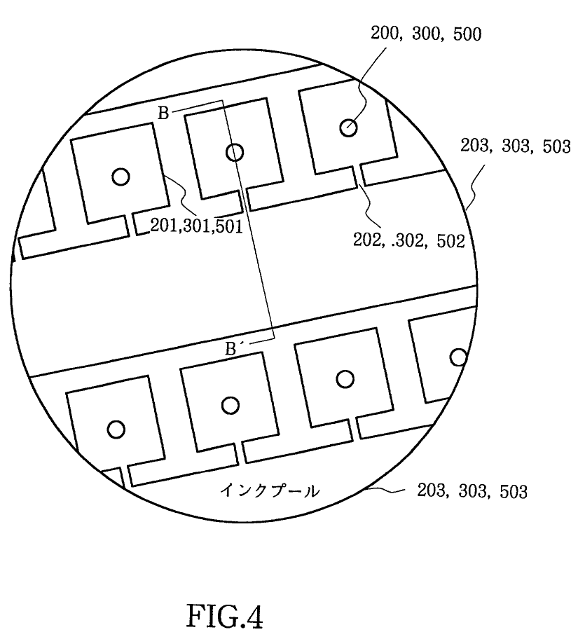

FIG. 1 is a plan view showing a whole ink jet head according to a first embodiment of the present invention, which includes a plurality of pairs 11 each of a nozzle and an ink chamber and a plurality of ink pools 12. In FIG. 1, the nozzle/ink chamber pairs llfor jetting ink are arranged adjacent to each other and the ink chambers are connected to a common ink pool 12 to form a unit matrix. FIG. 1 shows an example, which includes four unit matrices. In the unit matrix, the ink chambers are connected to a branch ink supply passage 13 and a plurality of the branch ink supply passages 13 are connected to a main ink supply passage 14, which is connected to an ink tank (not shown). FIG. 3 shows a portion of the unit matrix in a first and fourth embodiments of the present ink jet head in an enlarged scale and FIG. 4 shows a portion of the unit matrix in a second, third and fifth embodiments of the present invention in an enlarged scale. Portions shown by dotted lines in FIG. 3 show an ink pool on the nozzle side.

First Embodiment

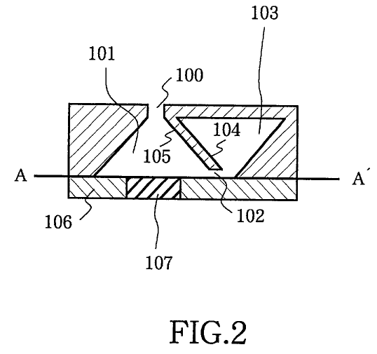

FIG. 2 is a cross section of the ink jet head according to the first embodiment of the present invention taken along a line B-B′ in FIG. 3, showing a structural feature of the first embodiment, and FIG. 3 is a plan view of the nozzles on a plane taken along a line A-A′ in FIG. 2, when looked from the side of a pressure generating mechanism, in which nozzles are not provided. In the first embodiment of the present invention, the nozzle 100, the ink chamber 101 and the ink pool 103 are formed in one substrate, as shown in FIG. 2. The ink chamber 101 has a tapered configuration and an upper end of the ink chamber 101 is connected to the nozzle 100. The ink pool 103 has a reverse-tapered configuration with respect to the ink chamber. In this embodiment, the substrate is a silicon (Si) substrate, in which the ink chamber 101 is constructed with four crystal faces {111} 105 and provides a square configuration in horizontal cross section as shown in FIG. 3. When the surface of the silicon substrate is face (100), the crystal face {111} 105 include (-1 -1 -1), (-1 -1 1), (-1 1 1) and (-1 1-1). When the surface of the silicon substrate is (010), the crystal face {111} 105 include (-1 -1 -1), (-1 -1 1), (1 -1 1) and (1 -1 -1) and, when the surface of the substrate is (001), the crystal face {111} 105 include (-1 -1 -1), (1 -1 -1), (1 1 -1) and (-1 1-1).

The ink chamber 101 and the ink pool 103 are connected each other through an ink supply port 102. The ink pool 103 is arranged adjacent to the ink chamber 101 and has a V grove structure constituted with two crystal face {111} 104. When the surface of the silicon substrate is (100), the crystal face {111} 104 include (1 1 1) and (1 -1 -1) or (1 1 -1) and (1 -1 1). When the surface of the silicon substrate is (010), the crystal face {111} 104 include (1 1 1) and (-1 1 -1) or (-1 1 1) and (1 1 -1) and, when the surface of the silicon substrate is (001), the crystal face {111} 104 include (1 1 1) and (-1 -1 1) or (1 -1 1) and (-1 1 1).

Since any one of the two crystal face {111} 104 is substantially in parallel to a certain face of the four crystal face {111} 105 constituting the ink chamber 101, it is possible to reduce a gap between the ink chamber 101 and the ink pool 103, that is, to arrange them at high density.

Since a partition wall separating the ink chamber 101 from the ink pool 103 is constituted with crystal face {111}, it is possible to form the wall having high aspect ratio precisely to thereby make the gap between the ink chamber 101 and the ink pool 103 extremely small.

Since the crystal face {111} provided by anisotropic wet-etching are very smooth, the problem of void discharge and/or ink stagnation in the ink chamber 101 and/or the ink pool 103 do not occur.

A piezo electric element 107 having a wiring (not shown) is arranged in a position in a thin film 106, which forms a bottom of the nozzle/ink chamber pair 11, corresponding to the ink chamber 101 as the pressure generating mechanism. Ink is supplied from an ink tank (not shown) to the ink pools 103. According to the experiments conducted by the present inventors, it has been confirmed that ink jetting performance of the piezo electric element 107 when a voltage is applied to the piezo electric element 107 is similar to that obtained conventionally. In this embodiment, it is possible to obtain similar effect by providing an ink heater in the thin film as the pressure generating mechanism, instead of the piezo electric element.

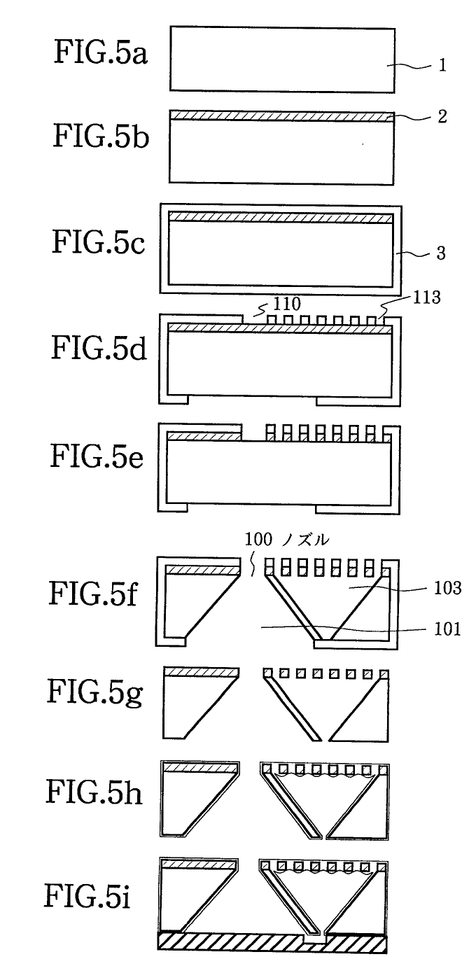

Now, a fabrication method of the ink jet head according to the first embodiment of the present invention will be described with reference to FIGS. 5a to 5i, which are cross sections of the ink jet head in the respective fabrication steps thereof. First, a high density boron diffusion layer 2 is formed on a Si wafer 1, which is shown in FIG. 5a and has crystal face {100}, (FIG. 5b). The Si wafer 1 used here is 300 μm thick and the high density boron diffusion layer 2 has a thickness of 10 μm.

Next, a silicon oxide film 3, which is 2 μm thick and becomes an etching resistive mask, is formed on a surface of the Si wafer 1 by thermal oxidation of the latter as shown in FIG. 5c. In this embodiment, the silicon oxide film is used as the etching resistive mask, that is, the resist film. However, the etching resistive mask is not limited to the silicon oxide film and any film such as a silicon nitride film or a metal film, which is durable against Si etching liquid, can be used therefor in the present invention including other embodiments to be described later.

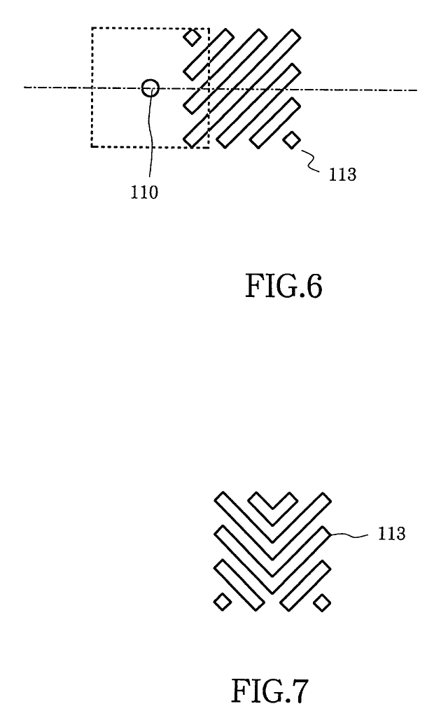

Next, after a resist film is painted on the Si wafer 1 and a resist mask pattern defining the nozzles 100 and the ink pools 103 is formed on the wafer surface by photolithography, the resist is selectively removed by etching the silicon oxide film 3 with using buffered hydrofluoric acid solution, resulting in a nozzle pattern 110 and an ink pool pattern 113 such as shown in FIG. 5d and FIG. 6, respectively.

In this case, the ink pool pattern 113 takes in the form of a plurality of thin grooves tilted with respect to an orientation flat by 45°, as shown in FIG. 6. Width of the groove is 1 μm and pitch of the pattern is 11 μm. The configuration of thin groove is not limited to the straight groove and any other configuration such as V-groove shown in FIG. 7 may be employed, provided that etchant can enter into the wafer through the groove to etch the inside of the wafer such that the wafer is hollowed out while leaving beams having width in the order of several microns. Thereafter, openings for forming the ink pools 103 and the nozzles 100 are formed in the high density boron diffusion layer 2 by dry-etching (FIG. 5e).

Next, the ink chamber 101 and the ink pool 103 are formed in the crystal face {111} by anisotropic wet-etching of Si, as shown in FIG. 5f. The wet-etching is performed in ethylenediamine pyrocatechol water (EPW) heated to about 100° C. At a time when the anisotropic wet-etching is completed, beams each 10 μm wide are arranged on the ink pool 103 with an interval of 1 μm.

Thereafter, the silicon oxide film 3 is removed by using hydrofluoric acid solution (FIG. 5g) and the Si wafer 1 is thermal-oxidized again at 1100° C. for about 3 hours in atmosphere of H₂:O₂=1:1 (FIG. 5h). The space (1 μm) between the beams arranged on the ink pool 103 is buried by a thermal oxide film newly formed on the Si wafer by thermal oxidation.

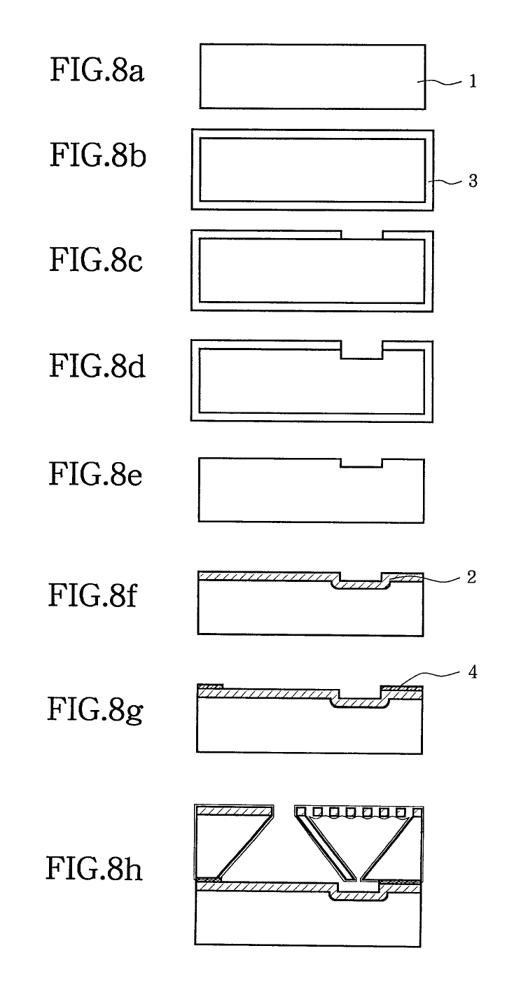

Thereafter, a vibration plate formed with the ink supply ports 102 is bonded to the Si wafer (FIG. 5i). In this embodiment, the vibration plate is a thin silicon film. An example of a fabrication method of the vibration plate will be described with reference to FIG. 8. First, the silicon oxide film 3, which is 5 μm thick and becomes the etching resistive mask, is formed on the surface of the Si wafer 1 as shown in FIG. 8a.

Then, after the resist film is painted on the Si wafer 1 and a resist mask pattern defining the ink supply ports 102 is formed on the wafer surface by photolithography, the resist is selectively removed by etching the silicon oxide film 3 with using buffered hydrofluoric acid solution, resulting in a nozzle pattern shown in FIG. 8c. Thereafter, the ink supply ports 102 are formed by dry-etching of silicon (FIG. 8d). The ink supply port 102 takes in the form of a groove having rectangular cross section, which is 100 μm long, 30 μm deep and 50 μm wide.

Thereafter, the silicon oxide film 3 is removed by using hydrofluoric acid solution (FIG. 8e) and, then, the high density boron diffusion layer 2 having thickness of 10 μm is formed (FIG. 8f). In this case, the configuration of the boron diffusion layer depends upon the surface configuration of the wafer.

Thereafter, a Pyrex glass 4 having thickness of 3 μm is deposited on the boron diffusion layer 2 by sputtering and is patterned by using hydrofluoric acid (FIG. 8g). The wafer is mated with the plate formed with the nozzles and the ink pools and electrostatic bonding is performed by applying a voltage of 400 V at 400° C. (FIG. 8h). In this electrostatic bonding, a negative voltage is applied to the side of the vibration plate (the side of the wafer on which the Pyrex glass is painted).

The vibration plate is completed by removing a portion of the wafer, in which high density boron is not diffused, by etching it with using KOH solution, etc.

The material of the vibration plate is not limited to silicon. Any other material such as glass, resin or metal may be used therefor, provided that it can efficiently transmit pressure to the ink chamber 101. Further, although the bonding of the parts is performed by electrostatic bonding method, similar effect can be obtained by using adhesive.

Finally, the piezo electric element (not shown) is arranged in a predetermined position and wired suitably and the ink jet head is completed by connecting the wafer to the ink tank (not shown). Since it is possible to form the electrically conductive layer by forming the high density boron diffusion layer, it is possible to avoid electrostatic charging when the nozzles 100 are wiped.

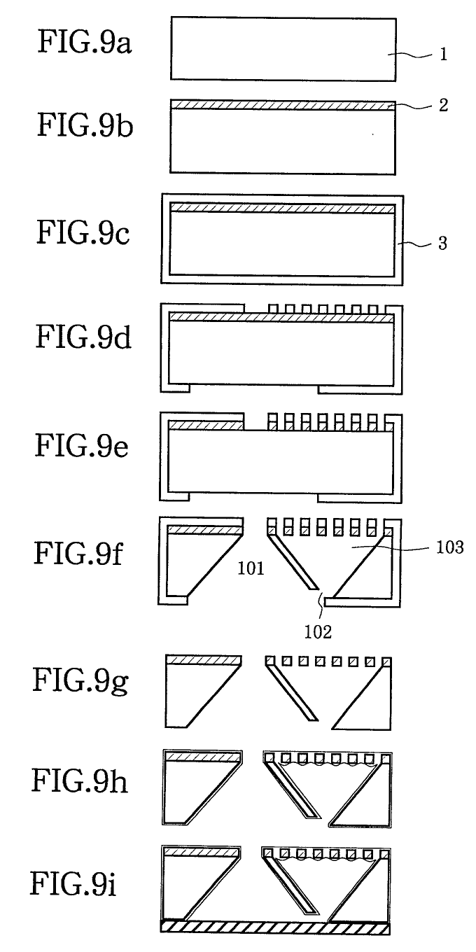

Next, a second fabrication method of the ink jet head according to the first embodiment of the present invention will be described with reference to FIGS. 9a to 9i. First, a high density boron diffusion layer 2 is formed on a Si wafer 1 shown in FIG. 9a and having crystal face {100} (FIG. 9b). The Si wafer 1 used here is 300 μm thick and the high density boron diffusion layer 2 has a thickness of 10 μm.

Next, a silicon oxide film 3, which is 2 μm thick and becomes an etching resistive mask, is formed on a surface of the Si wafer 1 by thermal oxidation thereof as shown in FIG. 9c.

Next, after a resist film is painted on the Si wafer 1 and a resist mask pattern defining the nozzles 100, the ink supply ports 102 and the ink pools 103 is formed on the wafer surface by photolithography, the resist is selectively removed by etching the silicon oxide film 3 with using buffered hydrofluoric acid solution, resulting in a pattern such as shown in FIG. 9d.

In this case, the pattern of the ink pools 103 takes in the form of a plurality of thin grooves tilted with respect to an orientation flat by 45° as shown in FIG. 6. Width of the groove is 1 μm and pitch of the pattern is 11 μm. The configuration of thin groove is not limited to the straight groove and any other configuration such as V-groove shown in FIG. 7 may be employed, provided that etchant can enter into the wafer through the groove to etch the inside of the wafer such that the wafer is hollowed out while leaving beams having width in the order of several microns.

Thereafter, openings for forming the ink pools 103 and the nozzles 100 are formed in the high density boron diffusion layer 2 by dry-etching (FIG. 9e).

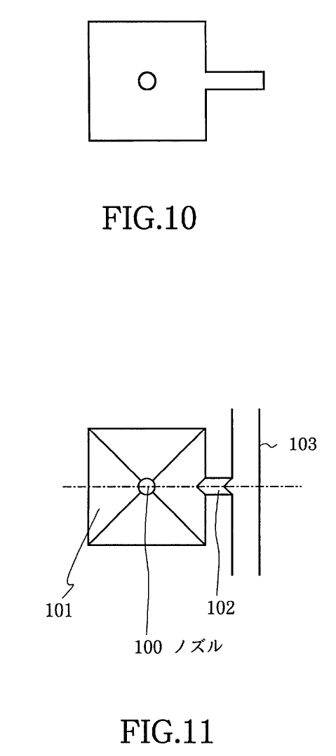

Next, the ink chambers 101, the ink supply ports 102 and the ink pools 103 are formed in the crystal face {111} by anisotropic wet-etching of Si, as shown in FIG. 9f. The wet-etching is performed in ethylenediamine pyrocatechol water (EPW) heated to about 100° C. At a time when the anisotropic wet-etching is completed, beams each 10 μm wide are arranged on the ink pool 103 with an interval of 1 μm. The pattern formed on a lower surface of the substrate is shown in FIG. 10 and FIG. 11 shows it in more detail.

Thereafter, the silicon oxide film 3 is removed by using hydrofluoric acid solution (FIG. 9g) and the Si wafer 1 is thermal-oxidized again at 1100° C. for about 3 hours in atmosphere of H₂:O₂=1:1 (FIG. 9h). The space (1 μm) between adjacent beams arranged on the ink pool 103 is buried by a thermal oxide film newly formed on the Si wafer by thermal oxidation.

Thereafter, a vibration plate formed with the ink supply ports 102 is bonded to the Si wafer (FIG. 9i). In this case, by eliminating the steps shown in FIGS. 8b to 8e, the vibration plate having no ink supply ports is obtained. As described previously, the electrostatic boding method is performed. That is, Pyrex glass 3 μm thick is deposited by sputtering and, after it is patterned by hydrofluoric acid, the vibration plate is mated with the plate formed with the nozzles and the ink pools. Then, a voltage of 400 V is applied thereto at 400° C. Thereafter, the portion of the wafer, which has no high density boron diffused, is etched away with using KOH solution, etc.

Finally, the piezo electric element (not shown) is arranged in a predetermined position and wired suitably and the ink jet head is completed by connecting the wafer to the ink tank (not shown).

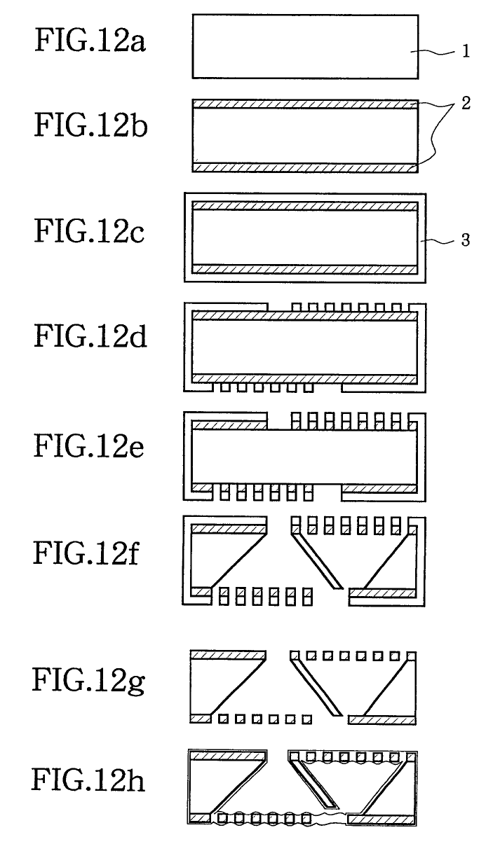

Next, a third fabrication method of the ink jet head according to the first embodiment of the present invention will be described with reference to FIGS. 12a to 12h. First, high density boron diffusion layers 2 are formed on both surfaces of a Si wafer 1 shown in FIG. 12a and having crystal face {l00} (FIG. 12b). The Si wafer 1 used here is 300 μm thick and the high density boron diffusion layers 2 each has a thickness of 10 μm.

Next, a silicon oxide film 3, which is 2 μm thick and becomes an etching resistive mask, is formed on the surfaces of the Si wafer 1 by thermal oxidation thereof as shown in FIG. 12c.

Next, after a resist film is painted on the Si wafer 1 and a resist mask pattern defining the nozzles 100, the ink chambers 101, the ink supply ports 102 and the ink pools 103 is formed on the wafer surface by photolithography, the resist is selectively removed by etching the silicon oxide film 3 with using buffered hydrofluoric acid solution, resulting in a pattern such as shown in FIG. 12d.

In this case, the patterns 111 and 112 of the ink chambers 101 and the ink supply ports 102 take in the form of a plurality of thin grooves tilted with respect to an orientation flat by 45° as shown in FIG. 6. Width of the groove is 1 μm and pitch of the pattern is 11 μm. The configuration of thin groove is not limited to the straight groove and any other configuration such as V-groove shown in FIG. 7 may be employed, provided that etchant can enter into the wafer through the groove to etch the inside of the wafer such that the wafer is hollowed out while leaving beams having width in the order of several microns.

Thereafter, the nozzles 100 and openings for forming the ink chambers 101, the ink supply ports 102 and the ink pools 103 are formed in the high density boron diffusion layer 2 by dry-etching (FIG. 12e).

Next, the ink chambers 101, the ink supply ports 102 and the ink pools 103 are formed in the crystal face {111} by anisotropic wet-etching of Si, as shown in FIG. 12f. The wet-etching is performed in ethylenediamine pyrocatechol water (EPW) heated to about 100° C. At a time when the anisotropic wet-etching is completed, beams each 10 μm wide are arranged on the ink chambers 101, the ink supply ports 102 and the ink pool 103 with an interval of 1 μm.

Thereafter, the silicon oxide film 3 is removed by using hydrofluoric acid solution (FIG. 12g) and the Si wafer 1 is thermal-oxidized again at 1100° C. for about 3 hours in atmosphere of H₂:O₂=1:1 (FIG. 12h). The space (1 μm) between adjacent beams arranged on the ink chambers 101, the ink supply ports 102 and the ink pool 103 is buried by a thermal oxide film newly formed on the Si wafer by thermal oxidation.

Finally, the piezo electric element (not shown) is arranged in a predetermined position and wired suitably and the ink jet head is completed by connecting the wafer to the ink tank (not shown).

Second Embodiment

FIG. 14 is a cross section of the ink jet head according to the second embodiment of the present invention taken along a line B-B′ in FIG. 4. Nozzles 400 are formed on a surface of a substrate and in communication with ink chambers 201, respectively. The ink chamber 201 is constructed with four crystal face {111} 205 and has a square cross section.

When the surface of the substrate is (100), the faces constituting the crystal face {111} 105 are (-1 -1 -1), (-1 -1 1), (-1 1 1) and (-1 1 -1). When the surface of the substrate is (010), the faces constituting the crystal face {111} 105 are (-1 -1 -1), (-1-1 1), (1 -1 1) and (1 -1 -1) and, when the surface of the substrate is (001), the faces constituting the crystal face {111} 105 are (-1 -1 -1), (1 -1 -1),(1 1 -1) and (-1 1 -1).

The ink chamber 201 and the ink pool 203 are connected each other through an ink supply port 202.

The ink pool 203 is arranged adjacent to the ink chamber 201 and has a V groove structure constituted with two faces of the crystal face {111} 204. When the surface of the silicon substrate is (100), the faces constituting the crystal face {111} 204 are (-1 -1 -1) and (-1 1 1) or (-1 -1 1) and (-1 1 1). When the surface of the silicon substrate is (010), the faces constituting the crystal face {111} 204 are (-1 -1 -1) and (1 -1 1) or (1 -1 -1) and (-1 -1 1) and, when the surface of the silicon substrate is (001), the faces constituting the crystal face {111} 204 are 1 -1 -1) and (1 1 -1) or (-1 1 -1) and (1 -1 -1).

Since it is possible to simultaneously form the ink chambers 201 and ink pools 203 from one of the surfaces of the substrate, it is possible to substantially reduce the process cost. Further, since it is possible to simultaneously pattern the ink chambers 201 and the ink pools 203 by photolithography, it is possible to reduce the positional error of the ink chambers 201 and the ink pools 203.

Since the crystal face {111} formed by anisotropic wet etching are very smooth, the problem of void discharge and/or ink stagnation in the ink chamber 201 and/or the ink pool 203 do not occur.

A pressure generating mechanism 207, which is wired suitably (not shown), is arranged in a position on a thin film 206 corresponding to each of the ink chambers. Ink is supplied from an ink tank (not shown) to the ink pools 203.

According to the experiments conducted by the present inventors, it has been confirmed that, when a voltage is applied to the pressure generating mechanism 207, ink jetting performance of the pressure generating mechanism 207 is similar to that obtained conventionally.

Although the piezo electric element is used as the pressure generating mechanism in this embodiment, it is possible to obtain similar effect by providing an ink heater in the thin film as the pressure generating mechanism.

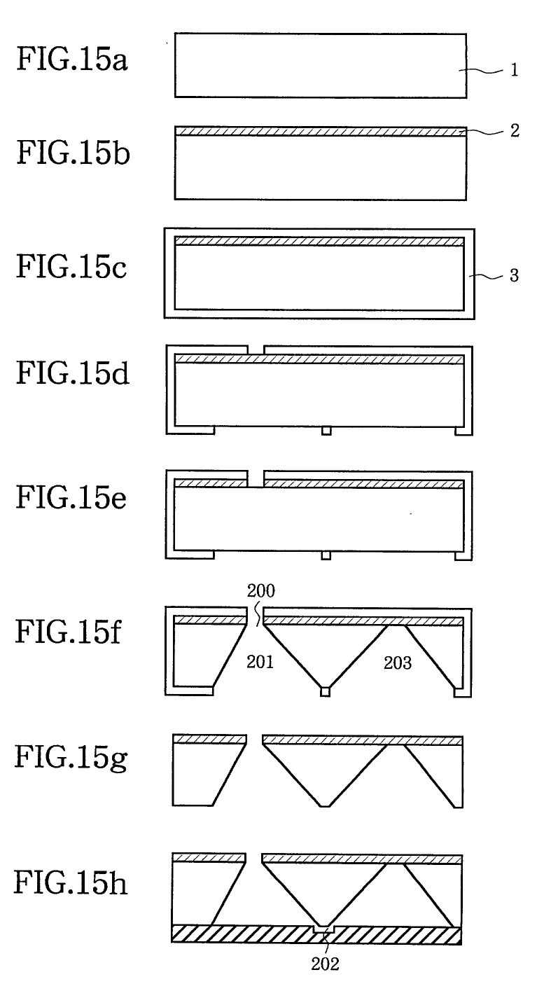

Now, a fabrication method of the ink jet head according to the second embodiment of the present invention will be described with reference to FIGS. 15a to 15h, which are cross sections of the ink jet head in the respective fabrication steps according to a first and second examples thereof. First, a high density boron diffusion layer 2 is formed on a Si wafer 1, which is shown in FIG. 15a and has crystal face {100} (FIG. 15b). The Si wafer 1 used here is 300 μm thick and the high density boron diffusion layer 2 has a thickness of 10 μm.

Next, a silicon oxide film 3, which is 2 μm thick and becomes an etching resistive mask, is formed on a surface of the wafer by thermal oxidation of the Si wafer 1 as shown in FIG. 15c.

Next, after a resist film is painted on the Si wafer 1 and a resist mask pattern defining the nozzles 200, the ink chambers 201 and the ink pools 103 is formed on the wafer surface by photolithography, the resist is selectively removed by etching the silicon oxide film 3 with using buffered hydrofluoric acid solution, resulting in a pattern shown in FIG. 15d.

Thereafter, the nozzles 200 are formed by dry-etching of the silicon (FIG. 15e).

Next, the ink chambers 201 and the ink pools 203 are formed in the crystal face {111} by anisotropic wet-etching of Si, as shown in FIG. 15f. The wet-etching is performed in ethylenediamine pyrocatechol water (EPW) heated to about 100° C.

Thereafter, the silicon oxide film 3 is removed by using hydrofluoric acid solution (FIG. 15g) and the vibration plate formed with the ink supply ports 202 is bonded to the Si wafer 1 (FIG. 15h). The method for forming the vibration plate is the same as that mentioned with respect to the first embodiment.

The ink supply ports 202 are formed in the substrate formed with the ink chambers 201 and the ink pools 203, by forming the pattern of the ink supply ports simultaneously at the time shown in FIG. 15d. In such case, since the vibration plate having no ink supply ports is to be used, the vibration plate may be fabricated without the steps shown in FIGS. 8b to 8e.

The material of the vibration plate is not limited to silicon. Any other material such as glass, resin or metal may be used therefor, provided that it can efficiently transmit pressure to the ink chamber 201. Further, although the bonding of the parts is performed by electrostatic bonding method, similar effect can be obtained by using adhesive.

Finally, the piezo electric element (not shown) is arranged in a predetermined position and wired suitably and the ink jet head is completed by connecting the wafer to the ink tank (not shown).

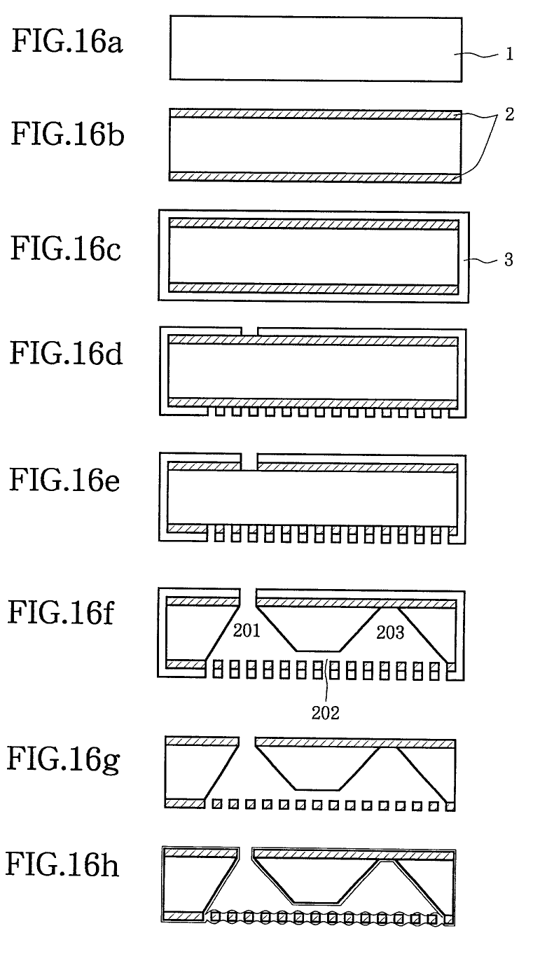

Next, a third fabrication method of the ink jet head according to the second embodiment of the present invention will be described with reference to FIGS. 16a to 16h. First, high density boron diffusion layers 2 are formed on both surfaces of a Si wafer 1 shown in FIG. 16a and having orientations {100} faces (FIG. 16b). The Si wafer 1 used here is 300 μm thick and the high density boron diffusion layers 2 each has a thickness of 10 μm.

Next, a silicon oxide film 3, which is 2 μm thick and becomes an etching resistive mask, is formed on the surfaces of the Si wafer 1 by thermal oxidation thereof as shown in FIG. 12c.

Next, after a resist film is painted on the Si wafer 1 and a resist mask pattern defining the nozzles 200, the ink chambers 201, the ink supply ports 202 and the ink pools 203 is formed on the wafer surface by photolithography, the resist is selectively removed by etching the silicon oxide film 3 with using buffered hydrofluoric acid solution, resulting in a pattern such as shown in FIG. 16d.

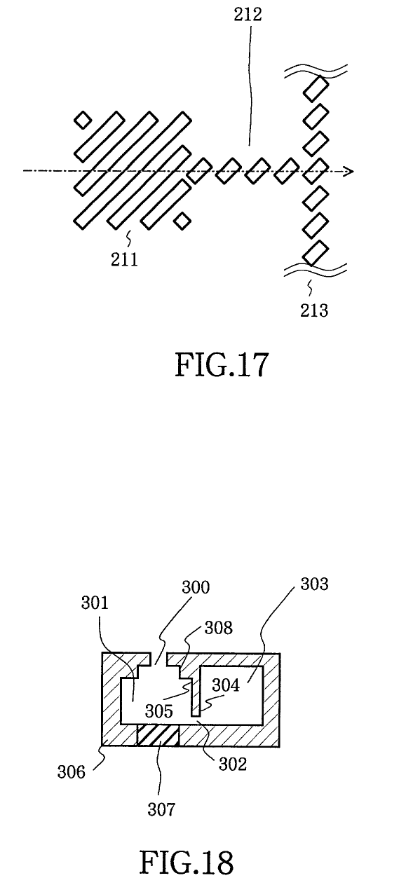

In this case, the patterns 211, 212 and 213 of the ink chambers 201, the ink supply ports 202 and the ink pools 203 take in the form of a plurality of thin grooves tilted with respect to an orientation flat by 45° as shown in FIG. 17. Width of the groove is 1 μm and pitch of the pattern is 11 μm. The configuration of thin groove is not limited to the straight groove and any other configuration such as V-groove shown in FIG. 7 may be employed, provided that etchant can enter into the wafer through the groove to etch the inside of the wafer such that the wafer is hollowed out while leaving beams having width in the order of several microns.

Thereafter, the nozzles 200 and openings for forming the ink chambers 201, the ink supply ports 202 and the ink pools 203 are formed in the high density boron diffusion layer 2 by dry-etching (FIG. 16e).

Next, the ink chambers 201, the ink supply ports 202 and the ink pools 203 are formed in the crystal face {111} by anisotropic wet-etching of Si, as shown in FIG. 16f. The wet-etching is performed in ethylenediamine pyrocatechol water (EPW) heated to about 100° C. At a time when the anisotropic wet-etching is completed, beams each 10 μm wide are arranged on the ink chambers 201, the ink supply ports 202 and the ink pool 203 with an interval of 1 μm.

Thereafter, the silicon oxide film 3 is removed by using hydrofluoric acid solution (FIG. 16g) and the Si wafer 1 is thermal-oxidized again at 1100° C. for about 3 hours in atmosphere of H₂:O₂=1:1 (FIG. 16h). The space (1 μm) between adjacent beams arranged on the ink chambers 201, the ink supply ports 202 and the ink pool 203 is buried by a thermal oxide film newly formed on the Si wafer by thermal oxidation.

Finally, the piezo electric element (not shown) is arranged in a predetermined position and wired suitably and the ink jet head is completed by connecting the wafer to the ink tank (not shown).

Third Embodiment

FIG. 18 is a cross section of the ink jet head according to a third embodiment of the present invention, taken along a line B-B′ in FIG. 4. In this embodiment, the surface of a substrate is any. Nozzles 300 are formed in a surface of the substrate and are in communication with ink chambers 301, respectively. The ink chamber 301 is constructed with face 305 perpendicular to the surface of the substrate and a horizontal cross section thereof is polygonal. The ink chamber 301 is in communication with the corresponding nozzle through at least one step portion 308. The horizontal cross section of the ink chamber may be circular. The ink chamber 301 and the ink pool 303 are connected each other through the ink supply port 302. The ink pool 303 is arranged adjacent to the ink chamber 301. The ink pool 303 is constructed with face 304 perpendicular to the surface of the substrate. Since the ink chamber 301 and the ink pool 303 can be partitioned by a partition wall perpendicular to the surface of the substrate, it is possible to reduce a distance between the ink chamber 301 and the ink pool 303. That is, the nozzles can be arranged at high density. The face formed by dry-etching is very smooth, the problem of void discharge and/or ink stagnation in the ink chamber 301 and/or the ink pool 303 do not occur.

A pressure generating mechanism 307 having wiring (not shown) is arranged in a position on a thin film 306 corresponding to each of the ink chambers. Ink is supplied from an ink tank (not shown) to the ink pools 303. According to the experiments conducted by the present inventors, it has been confirmed that, when a voltage is applied to the pressure generating mechanism 307, ink jetting performance of the pressure generating mechanism 307 is similar to that obtained conventionally. Although the piezo electric element is used in this embodiment as the pressure generating mechanism, it is possible to obtain similar effect by providing an ink heater in the thin film as the pressure generating mechanism.

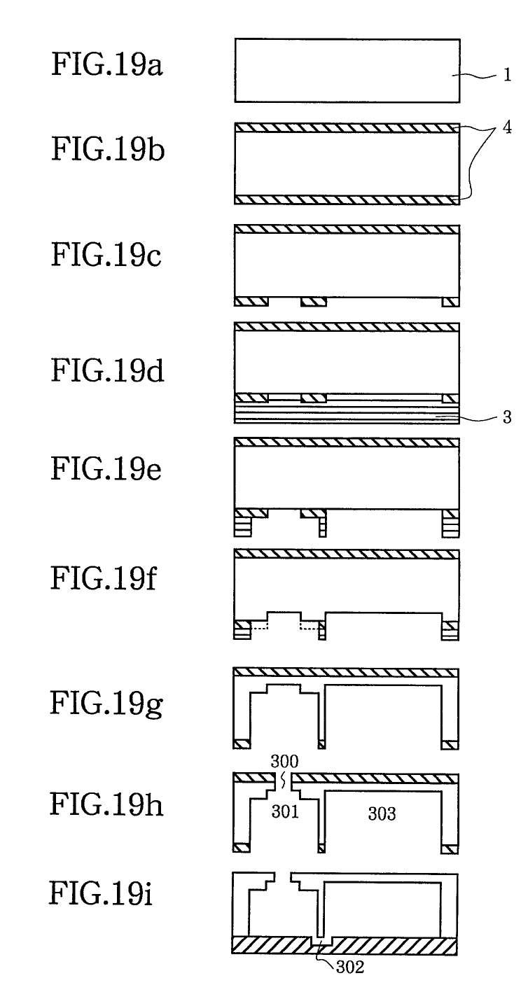

Now, a fabrication method of the ink jet head according to the third embodiment of the present invention will be described with reference to FIGS. 19a to 19i, which are cross sections of the ink jet head in the respective fabrication steps according to a first and second fabrication methods. First, silicon nitride films 4 having thickness of 0.5 μm are formed (FIG. 19b) on both surfaces of a Si wafer 1, which is shown in FIG. 19a and is 300 μm thick.

Next, after a resist film is painted on the Si wafer 1 and a resist mask pattern defining the step portions provided within the ink chambers 301 and the ink pools 303 is formed on the wafer surface by photolithography, the silicon nitride film 4 is selectively removed by dry-etching, resulting in a pattern shown in FIG. 19c.

Thereafter, a silicon oxide film 3 having thickness of 2.5 μm is formed on the surface, in which the pattern of the ink chambers 301 and the ink pools 303 are formed, by CVD, as shown in FIG. 19d.

Next, after a resist film is painted again on the Si wafer 1 and a resist mask pattern defining ink chambers 301 and the ink pools 303 are formed by photolithography, the silicon oxide film 3 is selectively etched away by buffered hydrofluoric acid solution, resulting in a pattern shown in FIG. 19e.

A deep silicon etching (dry-etching) is performed from the surface of the wafer, on which the pattern of the ink chambers 301 and the ink pools 303 is formed, by ICP system. Since, in the same etching, selective etching ratio of silicon for the silicon oxide film 3 and the silicon nitride film 4 is about 100, the silicon nitride film 4 having thickness of 0.5 μm provided in the step shown in FIG. 19b is broken (portion shown by broken line in FIG. 19f) at the time when the step portion 50 μm high in the ink chamber 301 is formed.

After the silicon nitride film 4 is broken, the etching of the pattern formed in the step shown in FIG. 19e is performed. The ink chambers 301 are etched while the step portions thereof are kept as they are. After the silicon nitride film 4 is broken, the etching down to a depth of 240 μm is performed (FIG. 19g).

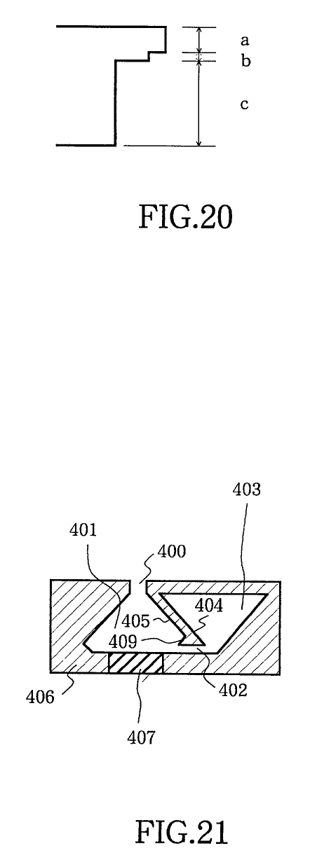

Thereafter, after a resist is painted on the Si wafer 1 and a resist pattern for forming the nozzles 300 in the predetermined locations on the wafer surface is formed by photolithography, the silicon nitride film 4 and the Si wafer 1 are dry-etched to remove the resist, resulting in the nozzles 300 as shown in FIG. 19h. Dimensions a, b and c of the ink chamber shown in FIG. 20 in this case are a=100 μm, b=50 μm and c=240 μm.

Thereafter, the silicon oxide film 3 is removed by using hydrofluoric acid solution and the vibration plate formed with the ink supply ports 302 is bonded to the Si wafer 1 (FIG. 19i). The method for forming the vibration plate is the same as that mentioned with respect to the first embodiment.

The ink supply ports 302 are formed in the substrate formed with the ink chambers 301 and the ink pools 303, by adding the forming step of the pattern of the ink supply ports after the step shown in FIG. 19g. In such case, since the vibration plate having no ink supply ports is to be used, the vibration plate may be fabricated without the steps shown in FIGS. 8b to 8e.

The material of the vibration plate is not limited to silicon. Any other material such as glass, resin or metal may be used therefor, provided that it can efficiently transmit pressure to the ink chamber 301. Further, although the bonding of the parts is performed by electrostatic bonding method, similar effect can be obtained by using adhesive.

Finally, the piezo electric element (not shown) is arranged in a predetermined position and wired suitably and the ink jet head is completed by connecting the wafer to the ink tank (not shown).

Fourth Embodiment

FIG. 21 is a cross section of the ink jet head according to the fourth embodiment of the present invention taken along a line B-B′ in FIG. 3.

Nozzles 400 are formed on a surface of a substrate and in communication with ink chambers 401, respectively. The ink chamber 401 is constructed with eight faces including four faces 405 and four faces 409 of crystal face {111} and has a square horizontal cross section.

When the surface of the substrate is (100), the faces 405 of the crystal face {111} are (-1 -1 -1), (-1 -1 1), (-1 1 1) and (-1 1 -1) and the faces 409 of the crystal face {111} are (1 1 1), (1 1 -1), (1 -1 -1) and ((1 -1 1). When the surface of the substrate is (010), the faces 405 of the crystal face {111} are (-1 -1 -1), (-1 -1 1), (1 -1 1) and (1 -1 -1) and the faces 409 of the crystal face {111} are (1 1 1), (-1 1 1), (-1 1 -1) and (1 1 -1). When the surface of the substrate is (001), the faces 405 of the crystal face {111} are (-1 -1 -1), (1 -1 -1), (1 1 -1) and (-1 1-1) and the faces 409 of the crystal face {111} are (1 1 1), (1 -1 1), (-1 -1 1) and (-1 1 1).

The ink chamber 401 has a configuration that a cross sectional area thereof gradually increases from a level of the nozzle 400 and gradually decreases from a certain level below the level of the nozzle 400. Since portions of the ink chamber 401, at which wall faces constructing the ink chamber 401 are put together, are formed as obtuse angles, ejection of void is so good that ink stagnation does not occur.

The ink chamber 401 and the ink pool 403 are connected each other through an ink supply port 402. The ink pool 403 is arranged adjacent to the ink chamber 401 and has a V grove structure constituted with two faces 404 of the crystal face {111}. When the surface of the silicon substrate is (100), the two faces 404 are (1 1 1) and (1 -1 -1) or (1 1 -1) and (1 -1 -1). When the surface of the silicon substrate is (010), the faces 404 are (1 1 1) and (-1 1 -1) or (-1 1 1) and (1 1 -1) and, when the surface of the silicon substrate is (001), the faces 404 are (1 1 1) and (-1 -1 1) or (1 -1 1) and (-1 1 1). Since either one of the two faces 404 of the crystal face {111} is substantially in parallel to a certain one of the faces 405 of the crystal face {111} constructing the ink chamber 401, it is possible to reduce the distance between the ink chamber 401 and the ink pool 403, that is, a high density arrangement of the ink chambers.

Since the partition wall partitioning the ink chamber 401 from the ink pool 403 is in the crystal face {111}, it is possible to form the wall having high aspect ratio with high precision to thereby reduce the distance between the ink chamber 401 and the ink pool 403.

Since, assuming that the bottom area of the ink chamber 401 is constant, this configuration allows the plate thickness to make larger compared with the configuration broaden toward the bottom, the workability such as handling, etc., is improved. Since a Si wafer having standard thickness can be used even when a 6″ Si wafer is used, it is possible to restrict the cost (thickness of 300 μm is not standard for the 6″ wafer).

Since the crystal face {111} formed by anisotropic wet etching are very smooth, the problem of void discharge and/or ink stagnation in the ink chamber 401 and/or the ink pool 403 do not occur.

A pressure generating mechanism 407 wired (not shown) is arranged in a position on a thin film 406 corresponding to each of the ink chambers. Ink is supplied from an ink tank (not shown) to the ink pools 403. According to the experiments conducted by the present inventors, it has been confirmed that, when a voltage is applied to the pressure generating mechanism, ink jetting performance of the pressure generating mechanism 407 is similar to that obtained conventionally. Although the piezo electric element is used as the pressure generating mechanism in this embodiment, it is possible to obtain similar effect by providing an ink heater in the thin film as the pressure generating mechanism.

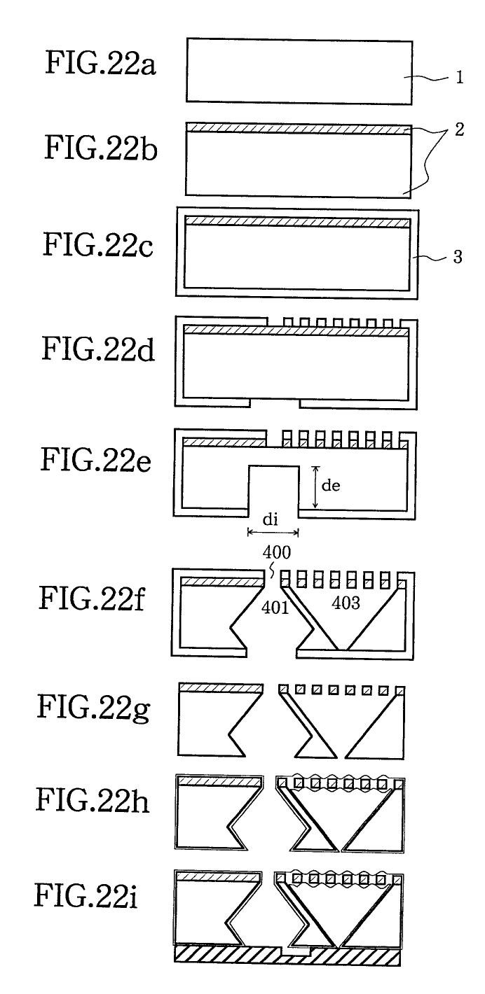

Now, a fabrication method of the ink jet head according to the fourth embodiment of the present invention will be described with reference to FIGS. 22a to 22i, which are cross sections of the ink jet head in the respective fabrication steps according to a first and second examples thereof. First, a high density boron diffusion layer 2 is formed on a Si wafer 1 having a surface in crystal face (100) and shown in FIG. 22a (FIG. 22b). The Si wafer 1 used here is 485 μm thick and the high density boron diffusion layer 2 has a thickness of 10 μm.

Next, a silicon oxide film 3, which is 2 μm thick and becomes an etching resistive mask, is formed on a surface of the wafer by thermal oxidation of the Si wafer 1 as shown in FIG. 22c.

Next, after a resist film is painted on the Si wafer 1 and a resist mask pattern defining the nozzles 400, the ink chambers 401 and the ink pools 403 is formed on the wafer surface by photolithography, the resist is selectively removed by etching the silicon oxide film 3 with using buffered hydrofluolic acid solution, resulting in a pattern shown in FIG. 22d.

In this case, the pattern of the ink pool 403 takes in the form of a plurality of thin grooves tilted with respect to an orientation flat by 45° as mentioned previously. Width of the groove is 1 μm and pitch of the pattern is 11 μm. The configuration of thin groove is not limited to the straight groove and any other configuration such as V-groove may be employed, provided that etchant can enter into the wafer through the groove to etch the inside of the wafer such that the wafer is hollowed out while leaving beams having width in the order of several microns

Thereafter, the nozzles 400 and openings for forming the ink pools 403 are formed by dry-etching of the silicon and deep openings for forming the ink chambers 401 are also formed by dry-etching of silicon (FIG. 22e). In this case, in order to form the ink chamber 401 such as shown in FIG. 22f, the following equation must be satisfied:

de+½(d+di)·tan 54.7°>t−b

where d is nozzle size, di is size of opening for dry-etching for forming the ink chamber, de is depth of opening for dry-etching for forming the ink chamber (except total thickness of silicon oxide film/high density boron diffusion layer), t is thickness of the substrate and b is total thickness of the high density boron diffusion layer.

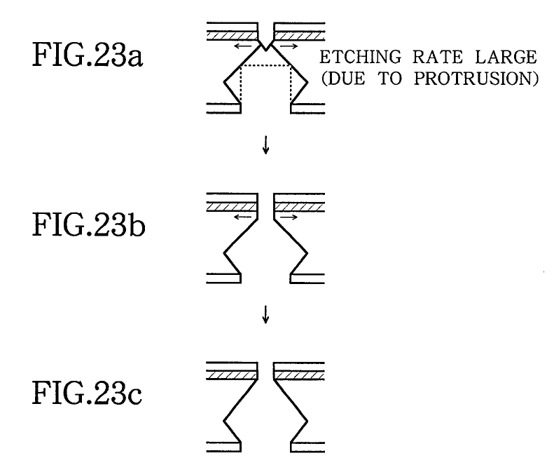

In this embodiment, di=440 μm and de=155 μm. Incidentally, the formation of the ink chambers 401 is shown in FIGS. 23a to 23c and, since a portion immediately below the nozzle 400 protrudes, the etching rate is high.

Next, the ink chambers 401 and the ink pools 403 are formed in the crystal face {111} by anisotropic wet-etching of Si, as shown in FIG. 22f. The wet-etching is performed in ethylenediamine pyrocatechol water (EPW) heated to about 100° C. At a time when anisotropic wet-etching is completed, beams each 10 μm wide are juxtaposed on the ink pool 403 with an internal of 1 μm.

Thereafter, the silicon oxide film 3 is removed by using hydrofluoric acid solution (FIG. 22g) and the Si wafer 1 is thermal-oxidized again at 1100° C. for about 3 hours in atmosphere of H₂:O₂=1:1 (FIG. 22h). The space (1 μm) between adjacent beams arranged on the ink pool 403 is buried by a thermal oxide film newly formed on the Si wafer by thermal oxidation.

Thereafter, the vibration plate formed with the ink supply ports 402 is bonded to the Si wafer 1 (FIG. 22i). The method for forming the vibration plate is the same as that mentioned with respect to the first embodiment.

The ink supply ports 402 are formed in the substrate formed with the ink chambers 401 and the ink pools 403, by forming the pattern of the ink supply ports simultaneously at the time shown in FIG. 22d. In such case, since the vibration plate having no ink supply port is to be used, the vibration plate may be fabricated without the steps shown in FIGS. 8b to 8e.

The material of the vibration plate is not limited to silicon. Any other material such as glass, resin or metal may be used therefor, provided that it can efficiently transmit pressure to the ink chamber 201. Further, although the bonding of the parts is performed by electrostatic bonding method, similar effect can be obtained by using adhesive.

Finally, the piezo electric element (not shown) is arranged in a predetermined position and wired suitably and the ink jet head is completed by connecting the wafer to the ink tank (not shown).

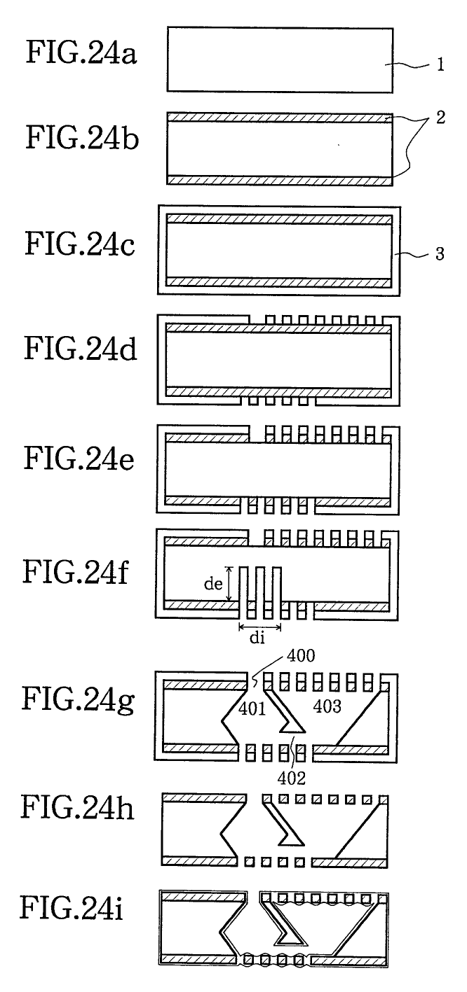

Next, a third fabrication method of the ink jet head according to the fourth embodiment of the present invention will be described with reference to FIGS. 24a to 24i. First, high density boron diffusion layers 2 are formed on both surfaces of a Si wafer 1, which are in crystal face {100} (FIG. 24b). The Si wafer 1 used here is 485 μm thick and the high density boron diffusion layers 2 each has a thickness of 10 μm.

Next, a silicon oxide film 3, which is 2 μm thick and becomes an etching resistive mask, is formed on the surfaces of the Si wafer 1 by thermal oxidation thereof as shown in FIG. 24c.

Next, after a resist film is painted on the Si wafer 1 and a resist mask pattern defining the nozzles 400, the ink chambers 401, the ink supply ports 402 and the ink pools 403 is formed on the wafer surface by photolithography, the resist is selectively removed by etching the silicon oxide film 3 with using buffered hydrofluoric acid solution, resulting in a pattern such as shown in FIG. 24d.

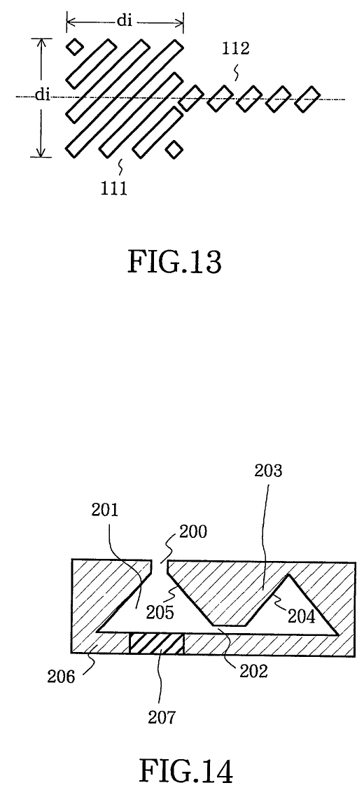

In this case, the patterns of the ink chambers 401, the ink supply ports 402 and the ink pools 403 take in the form of a plurality of thin grooves tilted with respect to an orientation flat by 45° as shown in FIG. 13. Width of the groove is 1 μm and pitch of the pattern is 11 μm. The configuration of thin groove is not limited to the straight groove and any other configuration such as V-groove shown in FIG. 7 may be employed, provided that etchant can enter into the wafer through the groove to etch the inside of the wafer such that the wafer is hollowed out while leaving beams having width in the order of several microns.

Thereafter, the nozzles 400 and openings for forming the ink chambers 401, the ink supply ports 402 and the ink pools 403 are formed in the high density boron diffusion layer 2 by dry-etching (FIG. 24e) and deep opening for forming the ink chambers 401 is also formed by dry-etching of silicon (FIG. 24f). In order to form the ink chamber 401 such as shown in FIG. 24g, the following equation must be satisfied:

de+½(d+di)·tan 54.7°>t−b

where d is nozzle size, di is size of opening for dry-etching for forming the ink chamber, de is depth of opening for dry-etching for forming the ink chamber (except total thickness of silicon oxide film/high density boron diffusion layer), t is thickness of the substrate and b is total thickness of the high density boron diffusion layer.

In this embodiment, di=440 μm and de=155 μm.

Next, the ink chambers 401, the ink supply ports 402 and the ink pools 403 are formed in the crystal face {111} by anisotropic wet-etching of Si, as shown in FIG. 24g. The wet-etching is performed in ethylenediamine pyrocatechol water (EPW) heated to about 100° C. At a time when anisotropic wet-etching is completed, beams each 10 μm wide are juxtaposed on the ink chambers 401, the ink supply ports 402 and the ink pools 403 with an internal of 1 μm.

Thereafter, the silicon oxide film 3 is removed by using hydrofluoric acid solution (FIG. 24h) and the Si wafer 1 is thermal-oxidized again at 1100° C. for about 3 hours in atmosphere of H₂:O₂=1:1 (FIG. 24i). The space (1 μm) between adjacent beams arranged on the ink chambers 401, the ink supply ports 402 and the ink pool 403 is buried by a thermal oxide film newly formed on the Si wafer by thermal oxidation.

Finally, the piezo electric element (not shown) is arranged in a predetermined position and wired suitably and the ink jet head is completed by connecting the wafer to the ink tank (not shown).

Fifth Embodiment

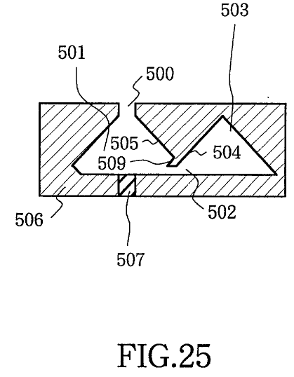

FIG. 25 is a cross section of the ink jet head according to the fifth embodiment of the present invention taken along a line B-B′ in FIG. 4.

Nozzles 500 are formed on a surface of a substrate and in communication with ink chambers 501, respectively. The ink chamber 401 is constructed with eight crystal faces including four faces 505 and four faces 509 of the crystal face {111} and has a square horizontal cross section.

When the surface of the substrate is (100), the faces 505 are (- 1-1 - 1), (- 1 -1 1), (-1 1 1) and (-1 1-1) and the faces 509 are (1 1 1), (1 1 -1), (1 -1 -1) and ((1 -1 1). When the surface of the substrate is (010), the faces 505 are (-1 -1 -1), (-1 -1 1), (1 -1 1) and (1 -1 -1) and the faces 509 are (1 1 1), (-1 1 1), (-1 1 -1) and (1 1 -1). When the surface of the substrate is (001), the faces 505 are (-1 -1 -1), (1 -1 -1), (1 1 -1) and (-1 1 -1) and the faces 509 are (1 1 1), (1 -1 1), (-1 -1 1) and (-1 1 1).

The ink chamber 501 has a configuration that a cross sectional area thereof gradually increases from a level of the nozzle 500 and gradually decreases from a certain level below the level of the nozzle 500. Since portions of the ink chamber 501, at which wall faces constructing the ink chamber 501 are put together, are formed as obtuse angles, ejection of void is so good that ink stagnation does not occur.

The ink chamber 501 and the ink pool 503 are connected each other through an ink supply port 502. The ink pool 503 is arranged adjacent to the ink chamber 501 and has a V grove structure constituted with two walls in two faces 504 of the crystal face {111}. When the surface of the silicon substrate is (100), the faces 504 are (-1 -1 -1) and (-1 1 1) or (-1 -1 1) and (-1 1 -1). When the surface of the silicon substrate is (010), the faces 504 are (-1 -1 -1) and (1 -1 1) or (1 -1-1) and (-1 -1 1) and, when the surface of the silicon substrate is (001), the faces 504 are (-1 -1 -1) and (1 1-1) or (-1 1 -1) and (1 -1 -1).

Since either one of the two faces 504 is substantially in parallel to a certain one of the faces 509 constructing the ink chamber 401, it is possible to reduce the distance between the ink chamber 501 and the ink pool 503, to thereby make a high density arrangement of the ink chambers possible.

Since the partition wall partitioning the ink chamber 501 from the ink pool 503 is in the crystal face {111}, it is possible to form the wall having high aspect ratio with high precision to thereby reduce the distance between the ink chamber 501 and the ink pool 503.

Since, assuming that the bottom area of the ink chamber 501 is constant, this configuration can increase the plate thickness compared with the configuration broaden toward the bottom, the workability such as handling, etc., is improved. Since a Si wafer having standard thickness can be used even when a 6″ Si wafer is used, it is possible to restrict the cost (thickness of 300 μm is not standard for the 6″ wafer).

Since the crystal face {111} formed by anisotropic wet-etching are very smooth, the problem of void discharge and/or ink stagnation in the ink chamber 501 and/or the ink pool 503 do not occur.

A pressure generating mechanism 507 having wiring (not shown) is arranged in a position on a thin film 506 corresponding to each of the ink chambers. Ink is supplied from an ink tank (not shown) to the ink pools 503.

According to the experiments conducted by the present inventors, it has been confirmed that, when a voltage is applied to the pressure generating mechanism 407, ink jetting performance of the pressure generating mechanism 407 is similar to that obtained conventionally. Although the piezo electric element is used as the pressure generating mechanism in this embodiment, it is possible to obtain similar effect by providing an ink heater in the thin film as the pressure generating mechanism.

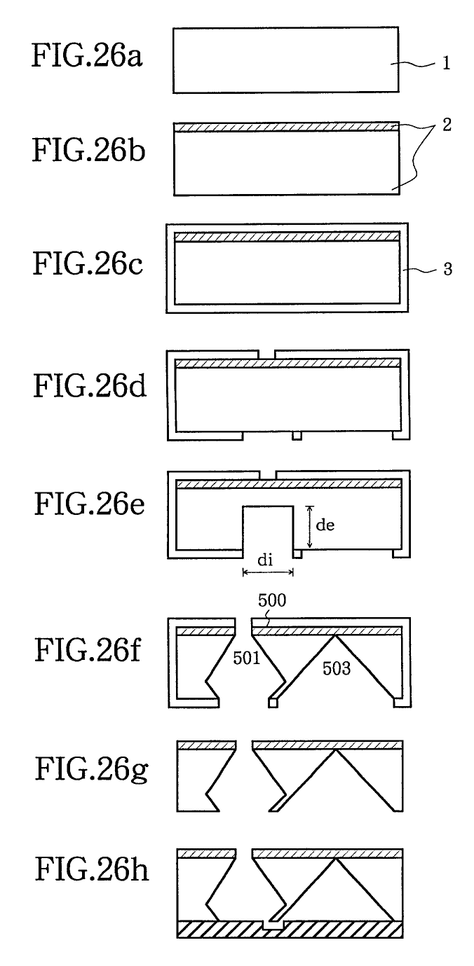

Now, a fabrication method of the ink jet head according to the fifth embodiment of the present invention will be described with reference to FIGS. 26a to 26h, which are cross sections of the ink jet head in the respective fabrication steps according to a first and second examples thereof.

First, a high density boron diffusion layer 2 is formed on a surface of a Si wafer 1, which is in crystal face {100} and shown in FIG. 26a (FIG. 26b). The Si wafer 1 used here is 485 μm thick and the high density boron diffision layer 2 has a thickness of 10 μm.

Next, a silicon oxide film 3, which is 2 μm thick and becomes an etching resistive mask, is formed on a surface of the wafer by thermal oxidation of the Si wafer 1 as shown in FIG. 26c.

Next, after a resist film is painted on the Si wafer 1 and a resist mask pattern defining the nozzles 500, the ink chambers 501 and the ink pools 503 is formed on the wafer surface by photolithography, the silicon oxide film 3 is selectively removed by etching with using buffered hydrofluoric acid solution, resulting in a pattern shown in FIG. 26d.

Thereafter, the nozzles 500 are formed by dry-etching of silicon and deep openings for forming the ink chambers 501 is also formed by dry-etching of silicon (FIG. 26e).

In this case, in order to form the ink chamber 501 such as shown in FIG. 26f, the following equation must be satisfied:

de+½(d+di)·tan 54.7°>t−b

where d is nozzle size, di is size of opening for dry-etching for forming the ink chamber, de is depth of opening for dry-etching for forming the ink chamber (except total thickness of silicon oxide film/high density boron diffusion layer), t is thickness of the substrate and b is total thickness of the high density boron diffusion layer.

In this embodiment, di=440 μm and de=155 μm.

Next, the ink chambers 501 and the ink pools 503 are formed in the crystal face {111} by anisotropic wet-etching of Si, as shown in FIG. 26f. The wet-etching is performed in ethylenediamine pyrocatechol water (EPW) heated to about 100° C.

Thereafter, the silicon oxide film 3 is removed by using hydrofluoric acid solution (FIG. 26g) and the vibration plate formed with the ink supply ports 502 is bonded to the Si wafer 1 (FIG. 26h). The method for forming the vibration plate is the same as that mentioned with respect to the first embodiment.

The ink supply ports 502 are formed in the substrate formed with the ink chambers 501 and the ink pools 503, by forming the pattern of the ink supply ports simultaneously at the time shown in FIG. 26d. In such case, since the vibration plate having no ink supply port is to be used, the vibration plate may be fabricated without the steps shown in FIGS. 8b to 8e.

The material of the vibration plate is not limited to silicon. Any other material such as glass, resin or metal may be used therefor, provided that it can efficiently transmit pressure to the ink chamber 501. Further, although the bonding of the parts is performed by electrostatic bonding method, similar effect can be obtained by using adhesive.

Finally, the piezo electric element (not shown) is arranged in a predetermined position and wired suitably and the ink jet head is completed by connecting the wafer to the ink tank (not shown).

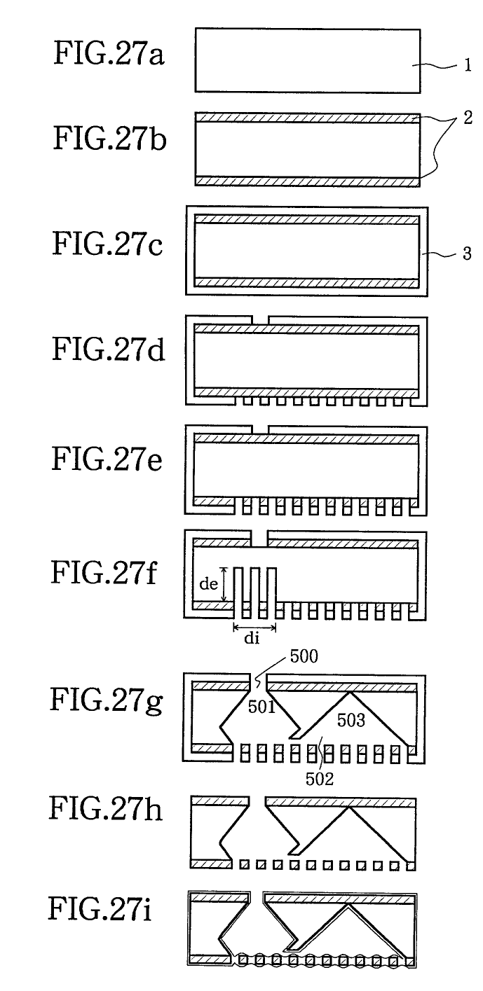

Next, a third fabrication method of the ink jet head according to the fifth embodiment of the present invention will be described with reference to FIGS. 27a to 27h. First, high density boron diffusion layers 2 are formed on both surfaces of a Si wafer 1 having crystal face {100} and shown in FIG. 27a (FIG. 27b). The Si wafer 1 used here is 300 μm thick and the high density boron diffusion layers 2 each has a thickness of 10 μm.

Next, a silicon oxide film 3 having a thickness of 2 μm, which becomes an etching resistive mask, is formed on the surfaces of the Si wafer 1 by thermal oxidation thereof as shown in FIG. 27c.

Next, after a resist film is painted on the Si wafer 1 and a resist mask pattern defining the nozzles 500, the ink chambers 501, the ink supply ports 502 and the ink pools 503 is formed on the wafer surface by photolithography, the silicon oxide film 3 is selectively removed by etching with using buffered hydrofluoric acid solution, resulting in a pattern such as shown in FIG. 27d.

In this case, the patterns of the ink chambers 501, the ink supply ports 502 and the ink pools 503 take in the form of a plurality of thin grooves tilted by 45° with respect to an orientation flat as shown in FIG. 13. Width of the groove is 1 μm and pitch of the pattern is 11 μm. The configuration of thin groove is not limited to the straight groove and any other configuration such as V-groove shown in FIG. 7 may be employed, provided that etchant can enter into the wafer through the groove to etch the inside of the wafer such that the wafer is hollowed out while leaving beams having width in the order of several microns.

Thereafter, the nozzles 500 and openings for forming the ink chambers 501, the ink supply ports 502 and the ink pools 503 are formed in the high density boron diffusion layer 2 by dry-etching (FIG. 27e) and deep opening for forming the ink chambers 501 is also formed by dry-etching of silicon (FIG. 27f).

In order to form the ink chamber 501 such as shown in FIG. 27g, the following equation must be satisfied:

de+½(d+di)·tan 54.7°>t−b

where d is nozzle size, di is size of opening for dry-etching for forming the ink chamber, de is depth of opening for dry-etching for forming the ink chamber (except total thickness of silicon oxide film/high density boron diffusion layer), t is thickness of the substrate and b is total thickness of the high density boron diffusion layer.

In this embodiment, di=440 μm and de=155 μm.

Next, the ink chambers 501, the ink supply ports 502 and the ink pools 503 are formed in the crystal face {111} by anisotropic wet-etching of Si, as shown in FIG. 27g. The wet-etching is performed in ethylenediamine pyrocatechol water (EPW) heated to about 100° C. At a time when anisotropic wet-etching is completed, beams each 10 μm wide are juxtaposed on the ink chambers 501, the ink supply ports 502 and the ink pools 503 with an internal of 1 μm.

Thereafter, the silicon oxide film 3 is removed by using hydrofluoric acid solution (FIG. 27h) and the Si wafer 1 is thermal-oxidized again at 1100° C. for about 3 hours in atmosphere of H₂:O₂=1:1 (FIG. 27i). The space (1 μm) between adjacent beams arranged on the ink chambers 501, the ink supply ports 502 and the ink pool 503 is buried by a thermal oxide film newly formed on the Si wafer by thermal oxidation..

Finally, the piezo electric element (not shown) is arranged in a predetermined position and wired suitably and the ink jet head is completed by connecting the wafer to the ink tank (not shown).

Sixth Embodiment

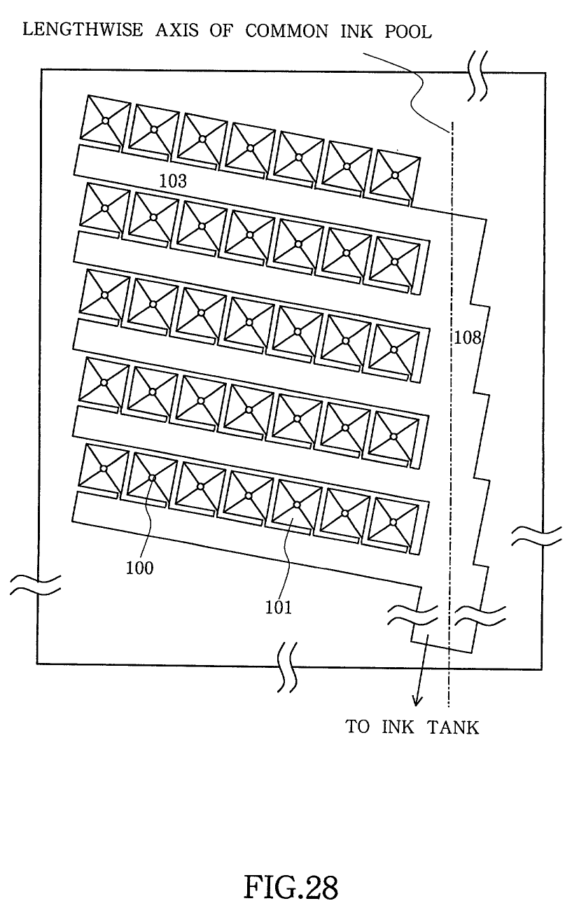

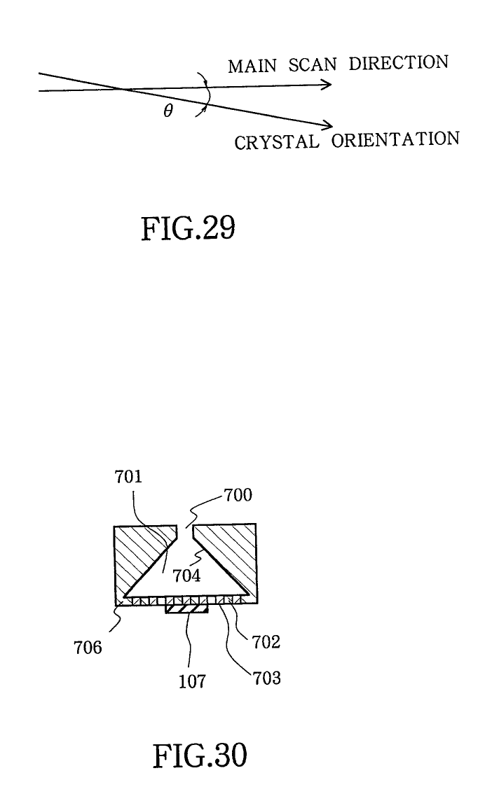

Next, a sixth embodiment of the present invention will be described. According to the sixth embodiment, an ink jet head includes nozzles and ink chambers, which are arranged in matrix. Cross sections of the nozzle 100, the ink chamber 101 and the ink pool 103 are the same as those described with reference to the first embodiment shown in FIG. 2. FIG. 28 is a view of the whole ink jet head when looked from a side thereof in which nozzles are not formed. The ink chambers, the ink pools (ink branch passages) and the common ink pool (ink main passage) are substantially the same as those in the embodiment shown in FIG. 1. FIG. 29 shows the angle of the main scan direction with respect to the line of the nozzles (or ink chambers) or the side direction of the ink pool, when the ink jet head is printing.

That is, the ink jet head according to the sixth embodiment comprises the nozzles 100 for jetting ink droplets, the ink chambers 101, which are provided correspondingly to the respective nozzles and in communication therewith, the ink pools 103 for supplying ink to the ink chambers 101, the ink supply ports 102 for connecting the ink chambers 101 to the ink pool 103 and the pressure generating mechanisms 107 for pressurizing the ink chambers 101, as shown in FIG. 2. The ink pool 103 forms a comb shaped ink passage such that a plurality of the ink pools 103 are jointed and connected to a common ink pool 108, which is connected to the ink tank (not shown).

The nozzles 100 are arranged in a line and row matrix as shown in FIG. 28 and the line of nozzles (or ink chambers) makes a constant angle 6 with respect to the main scan direction of the head during the printing as shown in FIG. 29.

In this embodiment, the cross section of the ink chamber 101 is square as shown in FIG. 4 and one of the sides forming its opening is in parallel to the side of the ink pool 103. Further, the side of the ink pool 103 and the wall face (partition wall face) of the ink chamber 101 are in the crystal face {111} of the silicon substrate and a longitudinal axis of the ink pool is in parallel to the crystal face {111}.

The extreme ends (extreme ends opposite to the common ink pool) of the nozzles 100 (or ink chambers 101) forming the lines are arranged on a straight line perpendicular to the main scan direction during the printing and the longitudinal axis of the common ink pool 108 to which the ink pools 103 are connected is in a direction perpendicular to the printing scan direction similarly to the row direction of the nozzles.

Next, a relation between the angle 0 between the line direction of the nozzles (or sides of the ink pools) and the printing scan direction and the resolution of the head will be described with reference to a case where the resolution N of the head is 300 dpi (or ppi), the nozzle pitch of the nozzles adjacent to the longitudinal direction of the ink pools 103 is 0.515 mm, the axis of the ink pool is tilted with respect to the printing scan direction by 9.46° and the nozzles positioned at the extreme ends are arranged on an axis tilted with respect to the crystal face {111} by 9.46°.

Therefore, the angle θ between the side of the ink pool on which the crystal face {111} appears and the printing scan direction becomes as follow:

0=arcsin 25.4/300/9.416°

When, for example, the nozzles and the ink chambers are arranged in a 36 (lines)×8 (rows) matrix and the line direction is tilted with respect to the main scan direction during printing by 9.466°, the lateral and vertical pitches of the nozzles (ink chambers) are 0.15 mm and 0.6681 mm, respectively. Therefore, in one ink jet head, 288 dots are arranged in a width of 23.7055 mm in the row direction.

The fabrication method of the ink jet head according to this embodiment is the same as that described with reference to the first embodiment. However, it is possible to perform the etching with high precision if the anisotropic etching is performed by facing the mask faces of the ink chambers arranged in the matrix and the corresponding ink pool mask face in parallel to the crystal face (crystal orientation [111]).

Since, in this embodiment, it is possible to efficiently arrange the nozzles, the in chambers and the ink pools with high density by utilizing the crystal faces, it is possible to make the ink jet head compact. Further, in cutting the ink jet head such that an outer configuration thereof extends along the main scan direction, it is possible to minimize the residual amount of function of the nozzles and the ink pools, which is necessary to perform the printing. Therefore, it is possible to reduce the loss on the silicon substrate to thereby reduce the fabrication cost.

Further, since the row direction of the nozzles is perpendicular to the printing direction, it is possible to jet ink droplets from the nozzles simultaneously in row direction. Therefore, the ink jetting control in the row direction is simpler compared with the case wherein the direction of nozzle rows is tilted with respect to the printing direction. Further, since the printing ends (printing start points on the left side of the printing sheet) are made aligned, the amount of movement of heads during printing is minimized.

In the sixth embodiment in which the nozzles and the ink pools are formed in one substrate, it is possible to improve the reliability of the head and the yield of parts to thereby realize the ink jet head having superior producibility. It is further possible to avoid electrostatic charging of the nozzles. Further, since the nozzles and the ink chambers can be arranged at high density, it is possible to make the high resolution ink jet head compact and to reduce the fabrication cost.

Next, a structure of the ink jet head, in which the pressure generating mechanisms for pressurizing ink in the ink chambers are provided on faces opposing to the nozzle openings through a thin-filmed portions of the substrate, will e described.

Seventh Embodiment

FIG. 30 is a cross section of the ink jet head according to the seventh embodiment of the present invention taken along a line perpendicular to the line B-B′ in FIG. 4.

Nozzles 700 are formed on a surface of a substrate and in communication with ink chambers 701, respectively. The ink chamber 701 is constructed with four faces 704 of crystal face {111} and has a square cross section. The ink chamber 701 is connected to an ink pool (not shown) through an ink supply port (not shown). A bottom of the ink chamber 701, which is opposing to the nozzle 700, is a thin film 706, which is etching residue when the ink chamber 701 is etched. The thin film 706 contains silicon diffused with boron at high density and silicon oxide or silicon nitride. Since such thin film 706 can be formed without necessity of specific bonding step by an adhesive, the number of fabrication steps can be reduced and ejection of void is not influenced adversely by pressed out portion of adhesive.

A wired piezo electric element 707 is arranged in a position of the thin film 706 corresponding to the chamber as the pressure generating mechanism and ink is supplied from an ink tank (not shown) to the ink pool. According to the experiments conducted by the present inventors by applying a voltage to the pressure generating mechanism 707, it has been confirmed that ink jetting performance of the pressure generating mechanism 707 is similar to that obtained conventionally. Although the piezo electric element is used as the pressure generating mechanism in this embodiment, it is possible to obtain similar effect by providing an ink heater in the thin film as the pressure generating mechanism.

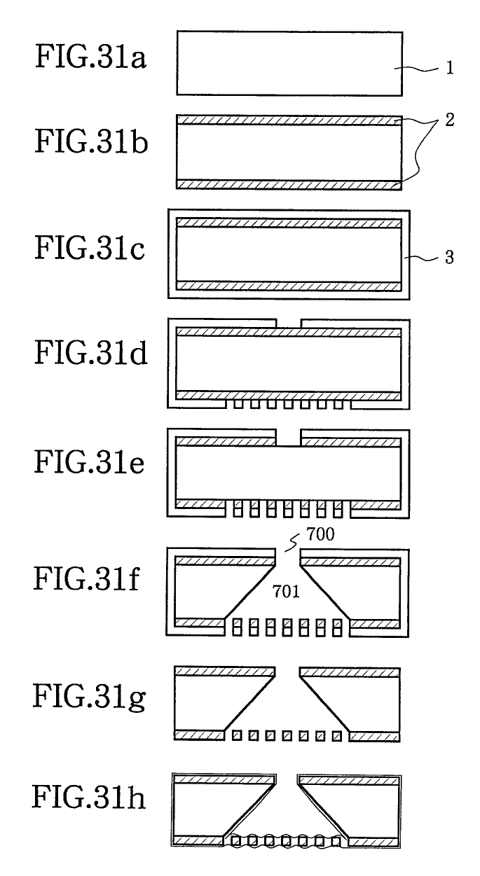

Now, a fabrication method of the ink jet head according to the seventh embodiment of the present invention will be described with reference to FIGS. 31a to 31h, which are cross sections of the ink jet head in the respective fabrication steps.

First, a high density boron diffusion layer 2 is formed on both surfaces of a Si wafer 1 having crystal orientation [100] and shown in FIG. 31a (FIG. 31b). The Si wafer 1 used here is 300 μm thick and the high density boron diffusion layer 2 has a thickness of 10 μm.

Next, a silicon oxide film 3, which is 2 μm thick and becomes an etching resistive mask, is formed on a surface of the wafer by thermal oxidation of the Si wafer 1 as shown in FIG. 31c. Although the silicon oxide film is used as the etching resistive mask in this embodiment, the etching resistive mask is not limited to the silicon oxide film and any film formed of a material silicon nitride or metal, which is durable against an etchant for silicon. This is true for embodiments to be described later.

Next, after a resist film is painted on the Si wafer 1 and a resist mask pattern defining the nozzles 700 and the ink chambers 701 is formed on the wafer surface by photolithography, the silicon oxide film 3 is selectively removed by etching with using buffered hydrofluoric acid solution, resulting in a pattern shown in FIG. 31d. In this case, the pattern of the ink chambers 701 is a thin groove pattern tilted with respect to the orientation flat by 45°. With of the groove is 1 μm and the pitch of the groove pattern is 11 μm. The configuration of thin groove is not limited to the straight groove and any other configuration such as V-groove shown in FIG. 7 may be employed, provided that etchant can enter into the wafer through the groove to etch the inside of the wafer such that the wafer is hollowed out while leaving beams having width in the order of several microns. Thereafter, the nozzles 700 and openings for forming the ink chambers 701 are formed by dry-etching (FIG. 31e).

Next, the ink chambers 701 are formed in the crystal face {111} by anisotropic wet-etching of Si, as shown in FIG. 31f The wet-etching is performed in ethylenediamine pyrocatechol water (EPW) heated to about 100° C. At a time when the anisotropic wet-etching is completed, beams each 10 μm wide and juxtaposed on the ink chamber 701 with interval of 1 μm.

Thereafter, the silicon oxide film 3 is removed by using hydrofluoric acid solution (FIG. 31g) and the Si wafer 1 is thermal-oxidized again at 1100° C. for about 3 hours in atmosphere of H₂:O₂=1:1 (FIG. 31i). The space (1 μm) between adjacent beams arranged on the ink chambers 701 is buried by a thermal oxide film newly formed on the Si wafer by thermal oxidation.

Finally, the piezo electric element (not shown) is arranged in a predetermined position and wired suitably and the ink jet head is completed by connecting the wafer to the ink tank (not shown).

Eighth Embodiment

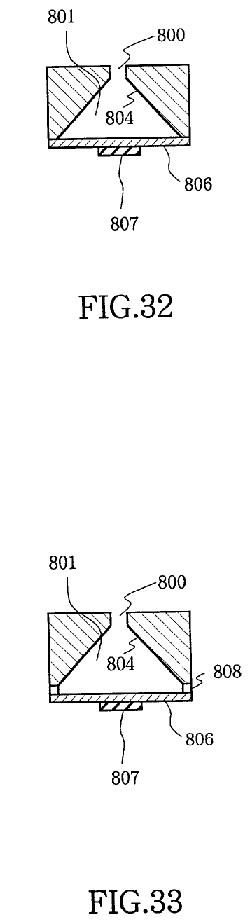

FIG. 32 is a cross section of the ink jet head according to the eighth embodiment of the present invention taken along a line perpendicular to the line B-B′ in FIG. 3 or 4. Nozzles 800 are formed on a surface of a substrate and in communication with ink chambers 801, respectively. The ink chamber 801 is constructed with four faces 804 having crystal orientation [111] and has a square cross section. The ink chamber 801 is connected to an ink pool (not shown) through an ink supply port (not shown). In this embodiment, a high density boron diffusion layer 806, which is provided as an etch stop layer, is used as a thin film for transmitting pressure. Since it is possible to form the thin film without any bonding with using an adhesive, the number of fabricating steps can be reduced and ejection of void is not influenced adversely by pressed out portion of adhesive.

A wired piezo electric element 807 is arranged in a position of the high density boron diffusion layer 806 corresponding to the chamber as the pressure generating mechanism and ink is supplied from an ink tank (not shown) to the ink pool. According to the experiments conducted by the present inventors by applying a voltage to the pressure generating mechanism 807, it has been confirmed that ink jetting performance of the pressure generating mechanism 807 is similar to that obtained conventionally. Although the piezo electric element is used as the pressure generating mechanism in this embodiment, it is possible to obtain similar effect by providing an ink heater in the thin film as the pressure generating mechanism.

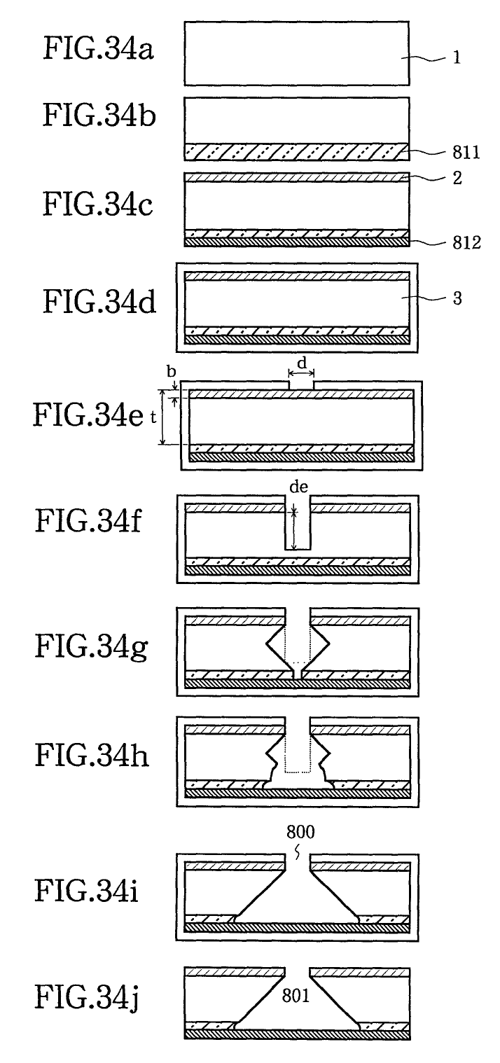

FIG. 33 is a cross section of an ink chamber, which is a modification of the eighth embodiment shown in FIG. 32. In the modification shown in FIG. 33, the high density boron diffusion layer 806 is provided through a polysilicon layer 808. Afabrication method of the ink jet head according to this modification will be described with reference to FIGS. 34a to 34j, which are cross sections of the ink jet head in the respective fabrication steps.

First, a polysilicon layer 811 is deposited on one surface of a Si wafer 1 having crystal orientation [100] shown in FIG. 34a (FIG. 34b). The Si wafer 1 used here is 300 μm thick and the polysilicon layer 811 has a thickness of 15 μm.

Next, high density boron diffusion layers 2 and 812 each 10 μm thick are formed on the both surfaces of the Si wafer 1, as shown in FIG. 34c. A silicon oxide film 3, which is 2 μm thick and becomes an anti-etching mask, is formed on the whole surface of the silicon wafer 1 by thermal oxidation of the latter as shown in FIG. 34d.

Next, after a resist film is painted on the Si wafer 1 and a resist mask pattern defining the nozzles 800 is formed on the wafer surface by photolithography, the silicon oxide film 3 is selectively removed by etching with using buffered hydrofluoric acid solution, resulting in a pattern shown in FIG. 34e.

Thereafter, the nozzles 800 are formed by dry-etching (FIG. 34f). In this case, in order to form the ink chamber 801 such as shown in FIG. 34i, the following equation must be satisfied:

de+½·d·tan 54.7°>t−b

where d is nozzle size, de is depth of opening for dry-etching for forming the ink chamber (except total thickness of silicon oxide film/high density boron diffusion layer), t is thickness of the substrate and b is total thickness of the high density boron diffusion layer.

In this embodiment, d=30 μm and de=270 μm.

Thereafter, by performing anisotropic wet-etching of silicon with using ethylenediamine pyrocatechol water (EPW) heated to about 100° C., a space surrounded by crystal faces having crystal orientation [111] is obtained as shown in FIG. 34g. In FIG. 34g, a bottom of the space reaches the polysilicon layer 811. By further performing the anisotropic wet-etching, the polysilicon layer 811 is etched laterally since the polysilicon has no crystal orientation. Protrusions appearing with the lateral etching are selectively etched (FIG. 34h) and, ultimately, flat faces having crystal orientation [111] appear (FIG. 34i), resulting in a desired polysilicon layer 808.

Finally, the silicon oxide film 3 is removed by using hydrofluoric acid solution (FIG. 34j) and the piezo electric element (not shown) is arranged in a predetermined position and wired suitably and the ink jet head is completed by connecting the wafer to the ink tank (not shown).

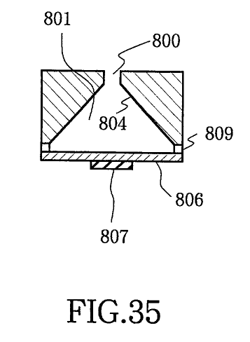

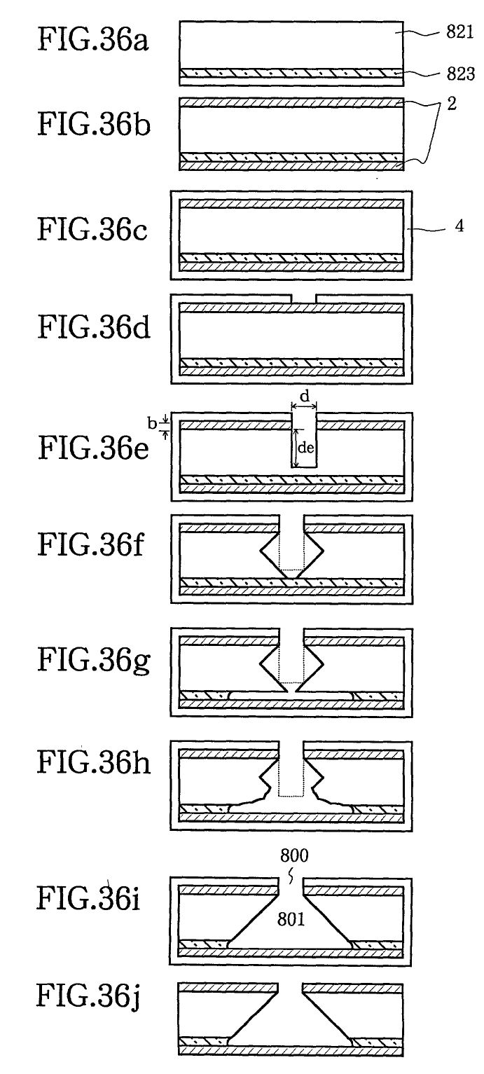

FIG. 35 is a cross section of an ink chamber, which is another modification of the eighth embodiment shown in FIG. 32. In the modification shown in FIG. 35, the high density boron diffusion layer 806 is provided through a SiO₂ layer 809. A fabrication method of the ink jet head according to this modification will be described with reference to FIGS. 36a to 36j, which are cross sections of the ink jet head in the respective fabrication steps.

First, a SOI (silicon-on-insulator) wafer having faces in crystal orientation [100] such as shown in FIG. 36a. The SOI wafer is composed of a silicon layer 821 having thickness of 300 μm, a silicon layer 823 having thickness of 10 μm and a SiO₂ layer 822 having thickness of 5 μm disposed between the silicon layers 821 and 823. High density boron diffusion layers 2 each 10 μm thick are formed on both surfaces of the SOI wafer, as shown in FIG. 36b.

Next, a silicon nitride film 4, which is 0.5 μm thick and becomes an etching resistive mask, is formed on the whole surface of the SOI wafer, as shown in FIG. 36c. After a resist film is painted on the SOI wafer and a resist mask pattern defining the nozzles 800 is formed on the wafer surface by photolithography, the silicon nitride film 4 is selectively removed by dry-etching, resulting in a pattern shown in FIG. 36d.

Thereafter, the nozzles 800 are formed by dry-etching (FIG. 36e). In this case, in order to form the ink chamber 801 such as shown in FIG. 36i, the following equation must be satisfied:

de+½·d·tan 54.7°>t1−b

where d is nozzle size, de is depth of opening for dry-etching for forming the ink chamber (except total thickness of silicon oxide film/high density boron diffusion layer), t1 is thickness of the substrate on the side of the nozzles and b is total thickness of the high density boron diffusion layer.

In this embodiment, d=30 μm and de=270 μm.

Thereafter, by performing anisotropic wet-etching of silicon with using ethylenediamine pyrocatechol water (EPW) heated to about 100° C., a space surrounded by faces in crystal orientation [111] is obtained as shown in FIG. 36f. In FIG. 36f, a bottom of the space reaches the Si0₂ layer 822. By further performing the etching by changing the etchant to hydrofluoric acid solution, the SiO₂ layer 822 is etched laterally (FIG. 36g).

After the etching of the bottom area of the ink chamber, which is obtained by the time management, is completed, the etchant is changed to ethylenediamine pyrocatechol water (EPW) heated to about 100° C., again, and the anisotropic wet-etching is continued. Protrusions appearing with the lateral etching are selectively etched (FIG. 36h) and, ultimately, flat faces having crystal orientation [111] appear (FIG. 36i), resulting in a desired polysilicon layer 808.

Finally, the silicon nitride film 4 is removed by using phosphoric acid solution (FIG. 36j) and the piezo electric element (not shown) is arranged in a predetermined position and wired suitably and the ink jet head is completed by connecting the wafer to the ink tank (not shown). The high density boron diffusion layer 2 is electrically conductive and, therefore, it is possible to avoid electrostatic charging of the head when the nozzles 800 are wiped, etc.

As described hereinbefore, according to the seventh and eighth embodiments, the bonding of the cover plate becomes unnecessary and the reliability of the head and the yield of parts thereof can be improved. Further, it is possible to avoid electrostatic charging of the opening portions of the nozzles.

What is claimed is:

1. An ink jet head comprising:
a substrate;
a plurality of ink nozzles formed in said substrate, for jetting ink droplets;
a plurality of ink chambers formed in said substrate and communicating with said ink nozzles, respectively, ink filing said ink chambers being pressurized; and
a plurality of ink pools each provided for a plurality of said ink chambers through partition walls, for supplying ink to said ink chambers, said partition walls being formed at a predetermined angle with respect to a surface of said substrate.

2. An ink jet head comprising:
a substrate;
a plurality of ink nozzles formed in said substrate, for jetting ink droplets;
a plurality of ink chambers formed in said substrate and communicating with said ink nozzles, respectively, ink filing said ink chambers being pressurized; and
a plurality of ink pools each provided adjacent to a plurality of said ink chambers through thin partition walls, for supplying ink to said ink chambers.

3. An ink jet head comprising:
a silicon substrate;
a plurality of nozzles provided in said silicon substrate perpendicularly to {100} face of said silicon substrate;
a plurality of ink chambers provided in said silicon substrate as wall faces including {111} faces of said silicon substrate, said ink chambers communicating with said nozzles, respectively, ink filling said ink chambers being pressurized;
a plurality of ink pools each provided adjacent to said ink chambers as wall faces in {111} faces of said silicon substrate, for supplying ink to said ink chambers.

4. An ink jet head comprising:
a substrate;
a plurality of nozzles formed in said substrate perpendicularly thereto;
a plurality of ink chambers formed in said substrate and communicating with said nozzles, respectively, ink filling said ink chambers being pressurized, each said ink chamber having a cross section tapered toward said nozzle;
a plurality of ink pools each provided for a plurality of said ink chambers through partition walls, for supplying ink to said ink chambers, said ink pool having a cross section tapered reversely to said ink chamber.

5. An ink jet head as claimed in claim 4, wherein a portion of said ink chamber is tapered reversely.

6. An ink jet head as claimed in claim 4, wherein an ink supply port is provided between said ink chamber and said ink pool.

7. An ink jet head as claimed in claim 4, wherein a cover plate formed with a plurality of ink supply grooves provided between said ink chamber and said ink pool is bonded to said substrate.

8. An ink jet head as claimed in claim 6 or 7, wherein a pressure generating mechanism is provided on the side of said ink chamber opposite to said nozzle, for pressurizing ink in said ink chamber.

9. An ink jet head comprising:
a substrate;
a plurality of nozzles formed in said substrate perpendicularly thereto;
a plurality of ink chambers formed in said substrate and communicating with said nozzles, respectively, ink filling said ink chambers being pressurized, each said ink chamber having a cross section tapered toward said nozzle; and
a plurality of ink pools provided adjacent to said ink chambers, for supplying ink to said ink chambers, said ink chambers and said ink pools having cross sections tapered toward a surface of said substrate, in which said nozzles are formed.

10. An ink jet head as claimed in claim 9, wherein a portion of said ink chamber is tapered reversely.

11. An ink jet head as claimed in claim 9, wherein an ink supply port is provided between said ink chamber and said ink pool.

12. An ink jet head as claimed in claim 9, wherein a cover plate formed with a plurality of ink supply grooves provided between said ink chamber and said ink pool is bonded to said substrate.

13. An ink jet head as claimed in claim 11 or 12, wherein a pressure generating mechanism is provided on the side of said ink chamber opposite to said nozzle, for pressurizing ink in said ink chamber.

14. An ink jet head comprising:
a substrate;
a plurality of nozzles formed in said substrate perpendicularly thereto;
a plurality of ink chambers formed in said substrate and communicating with said nozzles, respectively, ink filling said ink chambers being pressurized; and
a plurality of ink pools provided adjacent to said ink chambers, for supplying ink to said ink chambers, wall faces of said ink chambers and said ink pools being formed substantially perpendicularly to said substrate.

15. An ink jet head as claimed in claim 14, wherein said nozzle is stepped such that a diameter thereof is reduced from said ink chamber to said nozzle.

16. An ink jet head as claimed in claim 14, wherein an ink supply port is provided between said ink chamber and said ink pool.

17. An ink jet head as claimed in claim 14, wherein a cover plate formed with a plurality of ink supply grooves provided between said ink chamber and said ink pool is bonded to said substrate.

18. An ink jet head as claimed in claim 16 or 17, wherein a pressure generating mechanism is provided on the side of said ink chamber opposite to said nozzle, for pressurizing ink in said ink chamber.

19. A fabrication method for fabricating an ink jet head comprising the steps of:
forming a high density impurity diffusion layer on one surface of a silicon substrate;
forming an etching resistive mask film on the one surface of said silicon substrate;
forming opening portions for etching portions of said etching resistive mask film on said silicon substrate, in which ink chambers and ink pools are to be formed;
forming said ink chambers and said ink pools by anisotropic etching of said silicon substrate through said opening portions; and
closing said opening portions of said ink chambers and said ink pools thus formed.

20. A fabrication method for fabricating an ink jet head, as claimed in claim 19, wherein the step of forming said opening portions for forming said ink chambers and said ink pools includes the step of forming periodic grooves.

21. A fabrication method for fabricating an ink jet head, as claimed in claim 20, wherein the step of closing said opening portions of said ink chambers and said ink pools includes the step of oxidizing residual silicon in said opening portion.

22. A fabrication method for fabricating an ink jet head, as claimed in claim 19, wherein the step of forming said ink chambers and said ink pools by anisotropic etching includes the step of forming ink supply ports between said ink chambers and said ink pools.

23. A fabrication method for fabricating an ink jet head, as claimed in claim 19, wherein the step of forming said ink chambers and said ink pools by anisotropic etching includes the step of forming ink supply ports between said ink chambers and said ink pools, further comprising the step of: bonding a cover plate to said silicon substrate formed with said ink supply ports between said ink chambers and said ink pools.

24. A fabrication method for fabricating an ink jet head, as claimed in claim 19, wherein the step of closing said opening portions of said ink chambers and said ink pools includes the step of bonding a cover plate formed with ink supply grooves to portions of said silicon substrate between said ink chambers and said ink pools.

25. A fabrication method for fabricating an ink jet head, as claimed in claim 23 or 24, further comprising the step of forming piezo electric elements for exerting jetting pressure on ink filling said ink chambers on the sides of said ink chambers opposite to said nozzles.

26. A fabrication method for fabricating an ink jet head comprising the steps of:
forming high density impurity diffusion layers on both surfaces of a silicon substrate;
forming etching resistive mask films on the surfaces of said silicon substrate;
forming opening portions for etching, in portions of said etching resistive mask film on one of the surfaces of said silicon substrate, in which nozzles and ink pools are to be opened, and in portions of said etching resistive mask film on the other surface of said silicon substrate, in which ink chambers are to be formed;
forming said ink chambers and said ink pools by anisotropic etching of said silicon substrate through said opening portions;
closing said opening portions of said ink pools thus formed; and
closing said openings of said ink chambers thus formed.

27. A fabrication method for fabricating an ink jet head, as claimed in claim 26, wherein the step of forming said opening portions for forming said ink chambers and said ink pools includes the step of forming periodic grooves in said openings of said ink pools.

28. A fabrication method for fabricating an ink jet head, as claimed in claim 27, wherein the step of closing said opening portions of said ink chambers and said ink pools includes the step of oxidizing residual silicon in said opening portion.

29. A fabrication method for fabricating an ink jet head, as claimed in claim 28, wherein the step of forming said ink chambers and said ink pools by anisotropic etching includes the step of forming ink supply ports between said ink chambers and said ink pools, further comprising the step of: bonding a cover plate to said silicon substrate formed with said ink supply ports between said ink chambers and said ink pools.

30. A fabrication method for fabricating an ink jet head, as claimed in claim 28, wherein the step of closing said opening portions of said ink chambers and said ink pools includes the step of bonding a cover plate formed with ink supply grooves to portions of said silicon substrate between said ink chambers and said ink pools.

31. A fabrication method for fabricating an ink jet head, as claimed in claim 26, wherein the step of forming said ink chambers and said ink pools by anisotropic etching includes the step of forming ink supply ports between said ink chambers and said ink pools.

32. A fabrication method for fabricating an ink jet head, as claimed in claim 31, wherein the step of forming said ink chambers and said ink pools by anisotropic etching includes the step of forming ink supply ports between said ink chambers and said ink pools and the step of closing said opening portions of said ink chambers and said ink pools includes the step of oxidizing residual silicon in said opening portions of said ink pools.

33. A fabrication method for fabricating an ink jet head, as claimed in claim 26, wherein the step of forming said ink chambers and said ink pools by anisotropic etching includes the step of forming ink supply ports between said ink chambers and said ink pools, further comprising the step of bonding a cover plate to said silicon substrate formed with said ink supply ports between said ink chambers and said ink pools.

34. A fabrication method for fabricating an ink jet head, as claimed in claim 26, wherein the step of closing said openings of said ink chambers and said ink pools includes the step of bonding a cover plate formed with ink supply grooves in portions between said ink chambers and said ink pools to said silicon substrate.

35. A fabrication method for fabricating an ink jet head, as claimed in any of claims 30, 32, 33 and 34, further comprising the step of forming piezo electric elements for exerting jetting pressure on ink filling said ink chambers on the sides of said ink chambers opposite to said nozzles.

36. A fabrication method for fabricating an ink jet head, comprising the steps of:
forming etching resistive protection films on both surfaces of a silicon substrate;
forming opening portions for etching, in portions of said etching resistive mask film on the surfaces of said silicon substrate, in which ink chambers and ink pools are to be opened;
forming said ink chambers and said ink pools by dry-etching of said silicon substrate from an opposite surface of said silicon substrate to the surface thereof, in which nozzles are to be formed, to a predetermined depth through said opening portions; and
closing said opening portions of said ink chambers and said ink pools thus formed.

37. A fabrication method for fabricating an ink jet head, as claimed in claim 36, further comprising the step of forming nozzles by dry-etching, wherein, in the step of forming said ink chambers, top ends of said ink chambers have stepped portions.

38. A fabrication method for fabricating an ink jet head, as claimed in claim 36, wherein the step of forming said ink chambers and said ink pools includes the step of forming ink supply ports between said ink chambers and said ink pools, further comprising the step of bonding a cover plate to said silicon substrate formed with said ink supply ports between said ink chambers and said ink pools.

39. A fabrication method for fabricating an ink jet head, as claimed in claim 36, wherein the step of closing said opening portions of said ink chambers and said ink pools includes the step of bonding a cover plate formed with said ink supply grooves in portions corresponding to portions of said silicon substrate between said ink chambers and said ink pools to said silicon substrate.

40. A fabrication method for fabricating an ink jet head, as claimed in claim 38 or 39, farther comprising the step of forming piezo electric elements for exerting jetting pressure on ink filling said ink chambers on the sides of said ink chambers opposite to said nozzles.

41. A fabrication method for fabricating an ink jet head, comprising the steps of:
forming a high density impurity diffusion layer on one surface of a silicon substrate;
forming an etching resistive mask film on said high density impurity diffusion layer;
forming opening portions for etching, in portions of said etching resistive mask film on the one surface of said silicon substrate, in which ink chambers and ink pools are to be formed;
dry-etching said portions of said silicon substrate, in which said ink chambers are to be formed;
forming said ink chambers and said ink pools by anisotropic etching; and
closing said opening portions of said ink chambers and said ink pools thus formed.

42. A fabrication method for fabricating an ink jet head, as claimed in claim 41, wherein the step of forming said opening portions for forming said ink chambers and said ink pools includes the step of forming periodic grooves.

43. A fabrication method for fabricating an ink jet head, as claimed in claim 42, wherein the step of closing said opening portions of said ink chambers and said ink pools includes the step of oxidizing residual silicon in said opening portions.

44. A fabrication method for fabricating an ink jet head, as claimed in claim 41, wherein the step of forming said ink chambers and said ink pools by anisotropic etching includes the step of forming ink supply ports between said ink chambers and said ink pools.

45. A fabrication method for fabricating an ink jet head, as claimed in claim 41, wherein the step of forming said ink chambers and said ink pools by anisotropic etching includes the step of forming ink supply ports between said ink chambers and said ink pools, further comprising the step of bonding a cover plate to said silicon substrate formed with ink supply ports between said ink chambers and said ink pools.

46. Afabrication method for fabricating an ink jet head, as claimed in claim4l, wherein the step of closing said opening portions of said ink chambers and said ink pools includes the step of bonding a cover plate formed with ink supply grooves in portions thereof corresponding to portions of said silicon substrate between said ink chambers and said ink pools to said silicon substrate.

47. A fabrication method for fabricating an ink jet head, as claimed in any of claims 43, 45 and 46, further comprising the step of forming piezo electric elements for exerting jetting pressure on ink filling said ink chambers on the sides of said ink chambers opposite to said nozzles.

48. An ink jet head comprising:
a plurality of nozzles arranged in a matrix of lines tilted with respect to a main scan direction of said head by a constant angle and rows perpendicular to the main scan direction;
a plurality of ink chambers provided correspondingly to said nozzles, respectively, ink filling said ink chambers being pressurized;
a plurality of ink pools each provided along each line of said nozzles, for supplying ink to said ink chambers;
an ink supply passage connecting said ink chambers to said ink pool corresponding thereto;
a plurality of pressure generating mechanisms provided for generating pressure in said ink chambers,
wherein at least said ink chambers and said ink pools are formed in a crystalline plate and longer sides of said ink pools are coincident with a crystal face of said crystalline plate.

49. An ink jet head as claimed in claim 48, wherein said crystalline plate is a silicon substrate having surfaces coincident with {100} crystal face of silicon and said longer sides of said ink pool are in {111} crystal face silicon.

50. An ink jet head as claimed in claim 49, wherein each said ink chamber forms a pyramid having wall faces in {111} crystal face of silicon toward said nozzle and wall faces of each said ink pool in a shorter side direction are in parallel to said wall faces of said ink chamber and reverse tapered.

51. An ink jet head as claimed in claim 48, wherein one axis of each said ink pool is tilted with respect to a main scan direction by
θ=arcsin 25.4/N/L
where N is required resolution of said ink jet head in dpi and L is pitch between said nozzles adjacent in the longer side direction of said ink pool in millimeter.

52. An ink jet head as claimed in claim 48, wherein the direction of rows of said nozzles positioned in extreme ends in the nozzle lines is on an axis tilted with respect to the crystal orientation of said crystalline plate by
θ=arcsin 25.4/N/L.

53. An ink jet head as claimed in claim 48, wherein said ink pools formed along the nozzle lines are connected to a common ink pool and a longer side axis of said common ink pool is tilted with respect to the main scan direction by
θ=arcsin 25.4/N/L.

54. An ink jet head as claimed in claim 48, wherein an outer configuration of said ink jet head is constructed with four sides tilted with respect to the crystal orientation of the crystalline plate by
θ=arcsin 25.4/N/L.

55. An ink jet head as claimed in claim 48, wherein said ink jet head is moved in parallel to or perpendicularly to the sides constituting the outer configuration thereof when a printing is performed.

56. An ink jet head comprising:
a substrate;
a plurality of nozzle opening portions provided in one surface of said substrate for jetting ink droplets;
a plurality of ink chambers provided in said substrate and connected to said respective nozzle opening portions, ink filling said ink chambers being pressurized; and
pressure generating mechanisms for applying pressure to ink in said ink chambers, each said pressure generating mechanism being provided on the other surface of said substrate through a thinned portion of said substrate.

57. An ink jet head comprising:
a substrate;
a plurality of nozzle opening portions provided in one surface of said substrate, for jetting ink droplets; and
a plurality of ink chambers provided in said substrate and connected to said nozzle opening portions, ink in said ink chambers being pressurized, thinned portions of said substrate being left on bottoms of said ink chambers.

58. An ink jet head comprising:
a substrate;
a plurality of nozzle opening portions provided in one of surfaces of said substrate and extending perpendicularly to said substrate; and
a plurality of ink chambers provided in said substrate and connected to said nozzle opening portions, ink in said ink chambers being pressurized, wherein each said ink chamber has a cross section tapered to said nozzle opening portion and a bottom covered by residual portion of said substrate.

59. An ink jet head comprising:
a silicon substrate;
a plurality of nozzle opening portions provided in one of surfaces of said silicon substrate and extending in crystal orientation [100] perpendicular to {100} face of said substrate; and
a plurality of ink chambers provided in said silicon substrate as wall faces including {111} face and connected to said nozzle opening portions, ink in said ink chambers being pressurized, each said ink chamber being covered by residual silicon substrate on the other surface of said silicon substrate.

60. An ink jet head as claimed in claim 59, further comprising a plurality of ink pools connected to adjacent ink chambers through ink supply ports for supplying ink to said ink chambers.

61. An ink jet head comprising:
a silicon substrate;
a plurality of nozzle opening portions provided in one of surfaces of said silicon substrate and extending from said one surface perpendicularly into said silicon substrate; and
a plurality of ink chambers provided in said silicon substrate and connected to said nozzle opening portions, ink in said ink chambers being pressurized, each said ink chamber having a cross section tapered toward said nozzle opening portion by etching and a bottom covered by thin etching residue of said silicon substrate.

62. An ink jet head as claimed in claim 61, wherein said thin etching residue is formed by oxidizing silicon in the form of slits.

63. An ink jet head as claimed in claim 61, wherein said thin etching residue is formed by a high density impurity diffusion layer resistive to etching.

64. An ink jet head as claimed in claim 61, further comprising a plurality of ink pools each connected to adjacent ones of said ink chambers through a plurality of ink supply ports, for supplying ink to said ink chambers.

65. An ink jet head comprising:
a silicon substrate;
a polysilicon thin film formed on one of surfaces of said silicon substrate;
a plurality of nozzle opening portions provided in the other surface of said silicon substrate and extending from said the other surface perpendicularly into said silicon substrate; and
a plurality of ink chambers provided in said silicon substrate and connected to said nozzle opening portions, ink in said ink chambers being pressurized, each said ink chamber having a cross section tapered toward said nozzle opening portion by etching and a bottom covered by thin etching residue of said polysilicon thin film.

66. An ink jet head as claimed in claim 65, further comprising a plurality of ink pools each connected to adjacent ones of said ink chambers through a plurality of ink supply ports, for supplying ink to said ink chambers.

67. A ink jet head comprising:
a silicon substrate;
a silicon film or a polysilicon thin film formed on one of surfaces of said silicon substrate through a silicon oxide film;
a plurality of nozzle opening portions provided in the other surface of said silicon substrate and extending from said the other surface perpendicularly into said silicon substrate; and
a plurality of ink chambers provided in said silicon substrate and connected to said nozzle opening portions, ink in said ink chambers being pressurized, each said ink chamber having a cross section tapered toward said nozzle opening portion by etching and a bottom covered by thin etching residue of said silicon film or said polysilicon thin film.

68. An ink jet head as claimed in claim 67, further comprising a plurality of ink pools each connected to adjacent ones of said ink chambers through a plurality of ink supply ports, for supplying ink to said ink chambers.

69. A fabrication method for fabricating an ink jet head, comprising the steps of:
forming a high density impurity diffusion layer on one surface of said silicon substrate;
forming an etching resistive mask film on said one surface of said silicon substrate;
providing openings for etching in locations of said etching resistive mask film on said one suiface of said silicon substrate, at which a plurality of ink chambers are to be formed;
forming said ink chambers from said one surface by anisotropic etching; and
closing said opening portions of said ink chambers.

70. An ink jet head as claimed in claim 69, wherein the step of forming said opening portions for forming said ink chambers includes the step of forming periodic grooves.

71. An ink jet head as claimed in claim 70, wherein the step of closing said open portions of said ink chambers includes the step of oxidizing residual silicon on said open portions.

72. An ink jet head as claimed in claim 69, wherein crystal orientation of said surface of said silicon substrate is [100] and the step of anisotropic etching is performed such that crystal orientation of wall faces of each said ink chamber is [111].

73. An ink jet head as claimed in claim 69, wherein said high density impurity diffusion layer is a high density boron diffusion layer.

74. A fabrication method for fabricating an ink jet head, comprising the steps of:
forming a high density impurity diffusion layer on one surface of said silicon substrate;
forming an etching resistive mask film on said one surface of said silicon substrate;
providing openings for etching portions of the other surface of said silicon substrate, at which a plurality of ink chambers are to be formed, and forming openings deep enough to form said ink chambers in said silicon substrate by dry-etching; and
forming said ink chambers through said nozzle opening portions by anisotropic etching such that said high density impurity diffusion layer is left on the other surface of said silicon substrate.

75. An ink jet head as claimed in claim 74, wherein crystal orientation of said surface of said silicon substrate is [100] and the step of anisotropic etching is performed such that crystal orientation of wall faces of each said ink chamber is [111].

76. An ink jet head as claimed in claim 74, wherein said high density impurity diffusion layer is a high density boron diffusion layer.

77. A fabrication method for fabricating an ink jet head, comprising the steps of:
forming a polysilicon film on one surface of said silicon substrate;
forming a high density impurity diffusion layer on said polysilicon film;
forming nozzle opening portions from the other surface of said silicon substrate and forming openings deep enough to form ink chambers in said silicon substrate by dry-etching; and
forming said ink chambers through said nozzle opening portions by anisotropic etching such that said high density impurity diffusion layer is left on the other surface of said silicon substrate.

78. An ink jet head as claimed in claim 77, wherein crystal orientation of said surface of said silicon substrate is [100] and the step of anisotropic etching is performed such that crystal orientation of wall faces of each said ink chamber is [111].

79. An ink jet head as claimed in claim 77, wherein said high density impurity diffusion layer is a high density boron diffusion layer.

80. A fabrication method for fabricating an inkjet head, comprising the steps of:
forming a silicon film or a polysilicon film on one surface of a silicon substrate through a silicon oxide film;
forming a high density impurity diffusion layer on said silicon film or said polysilicon film and the other surface of said silicon substrate;
forming nozzle opening portions from the other surface of said silicon substrate and forming openings deep enough to form ink chambers in said silicon substrate by dry-etching; and
forming said ink chambers through said nozzle opening portions by anisotropic etching such that said high density impurity diffusion layer on said silicon film or said polysilicon film is left on said one of said silicon substrate.

81. A fabrication method for fabricating an ink jet head, as claimed in claim 80, wherein crystal orientation of said surface of said silicon substrate is [100] and the step of anisotropic etching is performed such that crystal orientation of wall faces of each said ink chamber is [111].

82. A fabrication method for fabricating an ink jet head, as claimed in claim 80, wherein said high density impurity diffusion layer is a high density boron diffusion layer.
